(19) United States
(12) Patent Application Publication
(10) Pub. No.: US 2026/0072944 A1
(43) Pub. Date: Mar. 12, 2026

(54) SYSTEM AND METHOD FOR AUTOMATED DATA WAREHOUSE CREATION AND EXTENSION FROM USER NATURAL LANGUAGE REQUESTS

(71) Applicant: ORACLE INTERNATIONAL CORPORATION, Redwood Shores, CA (US)

(72) Inventors: Sukanya Manna, Cupertino, CA (US); Saugata Chowdhury, Sunnyvale, CA (US); Somashekhar Pammar, San Jose, CA (US); Jonathan Vu, Fremont, CA (US); Sandeep Kadagathur Srinivasa Rao, Pleasanton, CA (US); Kamal Awasthi, Bengaluru (IN); Ritendra Bhattacharya, Bengaluru (IN); Saurav Mohapatro, San Ramon, CA (US); Krishnan Ramanathan, Bengaluru (IN); Karthik Bangalore Mani, Bengaluru (IN); Akash Baviskar, Bengaluru (IN); Dipawesh Pawar, Bengaluru (IN); Mayank Bansal, Bengaluru (IN); Jagdish Chand, Dublin, CA (US); Vikas Agrawal, Hyderabad (IN)

(21) Appl. No.: 19/209,602

(22) Filed: May 15, 2025

Related U.S. Application Data
(60) Provisional application No. 63/691,919, filed on Sep. 6, 2024.

(51) Int. Cl. G06F 16/28

(52) U.S. Cl. CPC G06F 16/283

(57) ABSTRACT

In accordance with an embodiment, described herein is a system and method for automated data warehouse creation and extension from user natural language requests. A data augmentation system, operating on one or more computers, can receive a natural language input from a user, including an instruction to augment a set of data, for example to create a fact/dimension, or to extend an existing data entity by bringing additional columns from a source data and publishing the combined data to a target data warehouse instance. The system determines an understanding associated with the user instruction in plain-language terms (for example, “extend sales order transactions with approval status”), and determines and performs a corresponding course of actions to create, extend, or otherwise augment the set of data, without requirement for the user to have a detailed knowledge of the data warehouse, its schemas, or other data dependencies.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM OF PRIORITY AND CROSS-REFERENCE TO RELATED APPLICATIONS

This application claims the benefit of priority to U.S. Provisional Patent Application titled “SYSTEM AND METHOD FOR AUTOMATED DATA WAREHOUSE CREATION AND EXTENSION FROM USER NATURAL LANGUAGE REQUESTS”, Application No. 63/691,919, filed Sep. 6, 2024; which application and the contents thereof are herein incorporated by reference.

### TECHNICAL FIELD

Embodiments described herein are generally related to data analytics environments, and are particularly directed to systems and methods for automated data warehouse creation and extension from user natural language requests.

### BACKGROUND

In the field of data analytics, data augmentation allows enterprise customers to enhance their existing sets of data with additional data. For example, a customer can develop datasets created by extending an existing data entity, or by adding a new data dimension, or a new data fact.

However, with current approaches, the process of data augmentation is generally not user-friendly. The user typically needs to have a detailed understanding of their system's existing configuration, and must then manually define each data attribute by navigating through various sets of instructions before they can execute a data analytics job.

### SUMMARY

In accordance with an embodiment, described herein is a system and method for automated data warehouse creation and extension from user natural language requests. A data augmentation system, operating on one or more computers, can receive a natural language input from a user, including an instruction to augment a set of data, for example to create a fact/dimension, or to extend an existing data entity by bringing additional columns from a source data and publishing the combined data to a target data warehouse instance. The system determines an understanding associated with the user instruction in plain-language terms (for example, “extend sales order transactions with approval status”), and determines and performs a corresponding course of actions to create, extend, or otherwise augment the set of data, without requirement for the user to have a detailed knowledge of the data warehouse, its schemas, or other data dependencies.

### BRIEF DESCRIPTION OF THE DRAWINGS

FIG. 1 illustrates an example data analytics system or environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 illustrates a system for automated data warehouse creation and extension from user natural language requests, in accordance with an embodiment.

FIG. 8 illustrates automated data warehouse creation and extension from user natural language requests, in accordance with various embodiments.

FIG. 9 further illustrates automated data warehouse creation and extension, in accordance with various embodiments.

FIG. 10 further illustrates automated data warehouse creation and extension, in accordance with various embodiments.

FIG. 11 further illustrates automated data warehouse creation and extension, in accordance with various embodiments.

FIG. 12 further illustrates automated data warehouse creation and extension, in accordance with various embodiments.

FIG. 13 further illustrates automated data warehouse creation and extension, in accordance with various embodiments.

FIG. 14 further illustrates automated data warehouse creation and extension, in accordance with various embodiments.

FIG. 15 further illustrates automated data warehouse creation and extension, in accordance with various embodiments.

FIG. 16 further illustrates automated data warehouse creation and extension, in accordance with various embodiments.

FIG. 17 further illustrates automated data warehouse creation and extension, in accordance with various embodiments.

FIG. 18 further illustrates automated data warehouse creation and extension, in accordance with various embodiments.

FIG. 19 further illustrates automated data warehouse creation and extension, in accordance with various embodiments.

FIG. 20 further illustrates automated data warehouse creation and extension, in accordance with various embodiments.

FIG. 21 further illustrates automated data warehouse creation and extension, in accordance with various embodiments.

FIG. 22 further illustrates automated data warehouse creation and extension, in accordance with various embodiments.

FIG. 23 further illustrates automated data warehouse creation and extension, in accordance with various embodiments.

FIG. 24 further illustrates automated data warehouse creation and extension, in accordance with various embodiments.

FIG. 25 further illustrates automated data warehouse creation and extension, in accordance with various embodiments.

FIG. 26 further illustrates automated data warehouse creation and extension, in accordance with various embodiments.

FIG. 27 further illustrates automated data warehouse creation and extension, in accordance with various embodiments.

FIG. 28 further illustrates automated data warehouse creation and extension, in accordance with various embodiments.

FIG. 29 further illustrates automated data warehouse creation and extension, in accordance with various embodiments.

FIG. 30 illustrates a process automated data warehouse creation and extension, in accordance with various embodiments.

FIG. 31 illustrates an example use of automated data warehouse creation and extension from user natural language requests, in accordance with various embodiments.

FIG. 32 further illustrates an example use of automated data warehouse creation and extension from user natural language requests, in accordance with various embodiments.

FIG. 33 further illustrates an example use of automated data warehouse creation and extension from user natural language requests, in accordance with various embodiments.

FIG. 34 further illustrates an example use of automated data warehouse creation and extension from user natural language requests, in accordance with various embodiments.

FIG. 35 further illustrates an example use of automated data warehouse creation and extension from user natural language requests, in accordance with various embodiments.

FIG. 36 further illustrates an example use of automated data warehouse creation and extension from user natural language requests, in accordance with various embodiments.

### DETAILED DESCRIPTION

In the field of data analytics, data augmentation allows enterprise customers to enhance their existing sets of data with additional data. For example, a customer can develop datasets created by extending an existing data entity, or by adding a new data dimension, or a new data fact.

However, with current approaches, the process of data augmentation is generally not user-friendly. The user typically needs to have a detailed understanding of their system's existing configuration, and must then manually define each data attribute by navigating through various sets of instructions before they can execute a data analytics job.

In accordance with an embodiment, described herein is a system and method for automated data warehouse creation and extension from user natural language requests. A data augmentation system, operating on one or more computers, can receive a natural language input from a user, including an instruction to augment a set of data, for example to create a fact/dimension, or to extend an existing data entity by bringing additional columns from a source data and publishing the combined data to a target data warehouse instance. The system determines an understanding associated with the user instruction in plain-language terms (for example, “extend sales order transactions with approval status”), and determines and performs a corresponding course of actions to create, extend, or otherwise augment the set of data, without requirement for the user to have a detailed knowledge of the data warehouse, its schemas, or other data dependencies.

### Data Analytics Environments

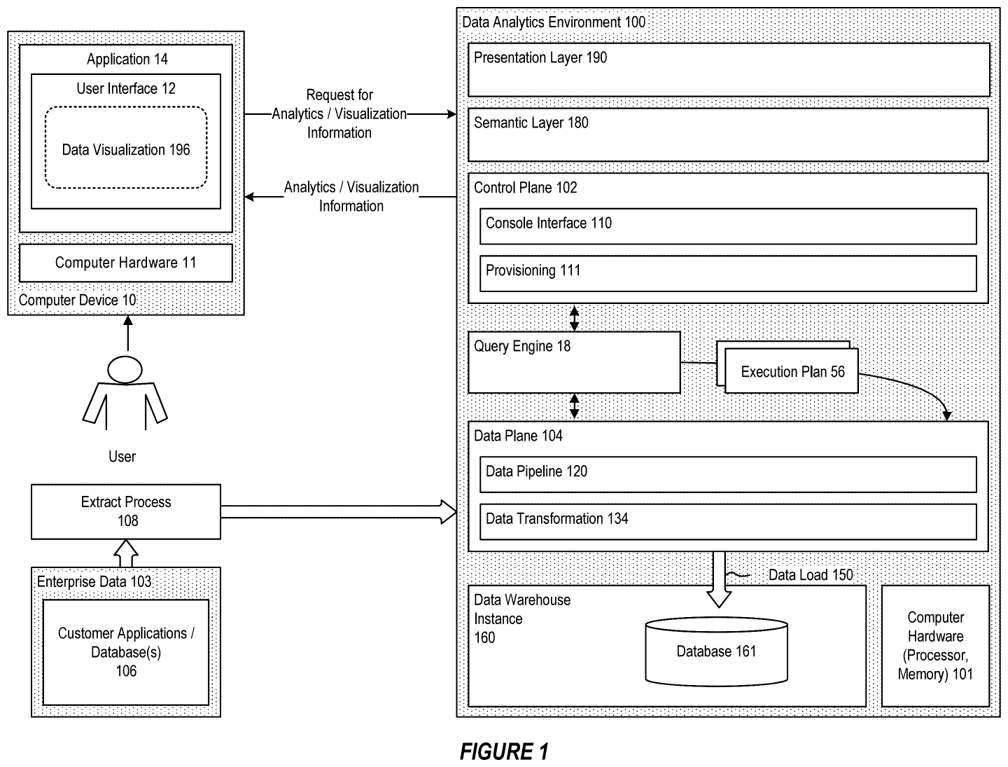

FIG. 1 illustrates an example data analytics environment, in accordance with an embodiment.

The embodiment illustrated in FIG. 1 is provided for illustrating an example data analytics environment in association with which various embodiments described herein can be used. The components and processes illustrated in FIG. 1 and as described elsewhere herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

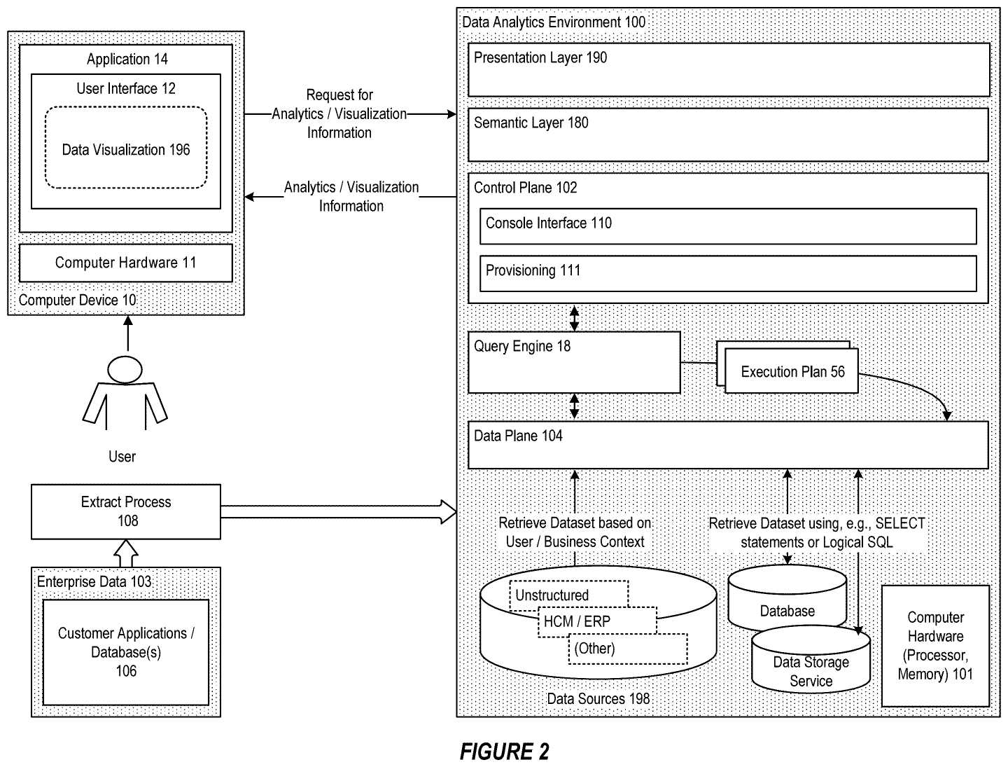

FIG. 2 further illustrates an example data analytics environment, in accordance with an embodiment.

As illustrated in FIG. 2, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

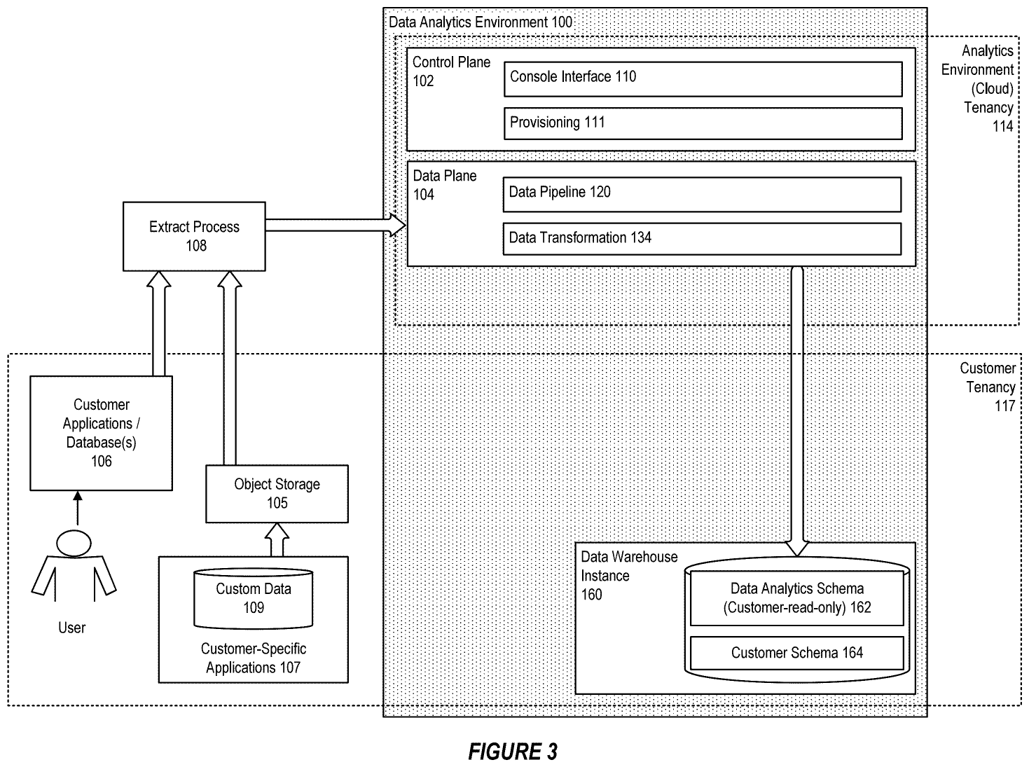

FIG. 3 further illustrates an example data analytics environment, in accordance with an embodiment.

As illustrated in FIG. 3, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

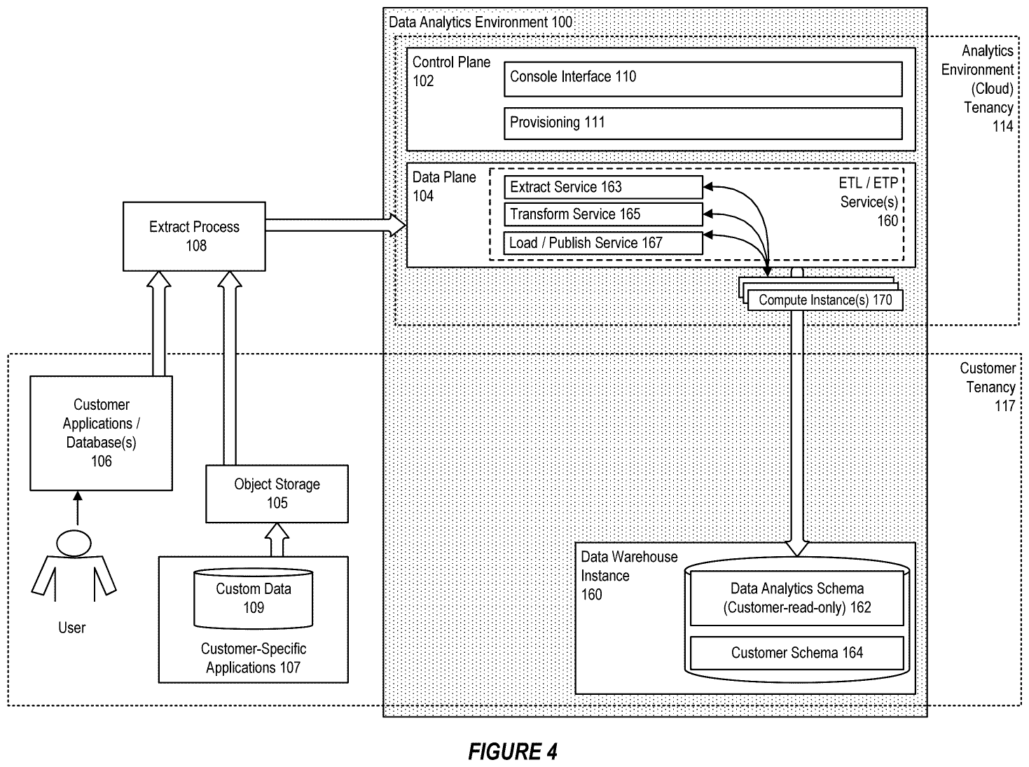

FIG. 4 further illustrates an example data analytics environment, in accordance with an embodiment.

As illustrated in FIG. 4, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

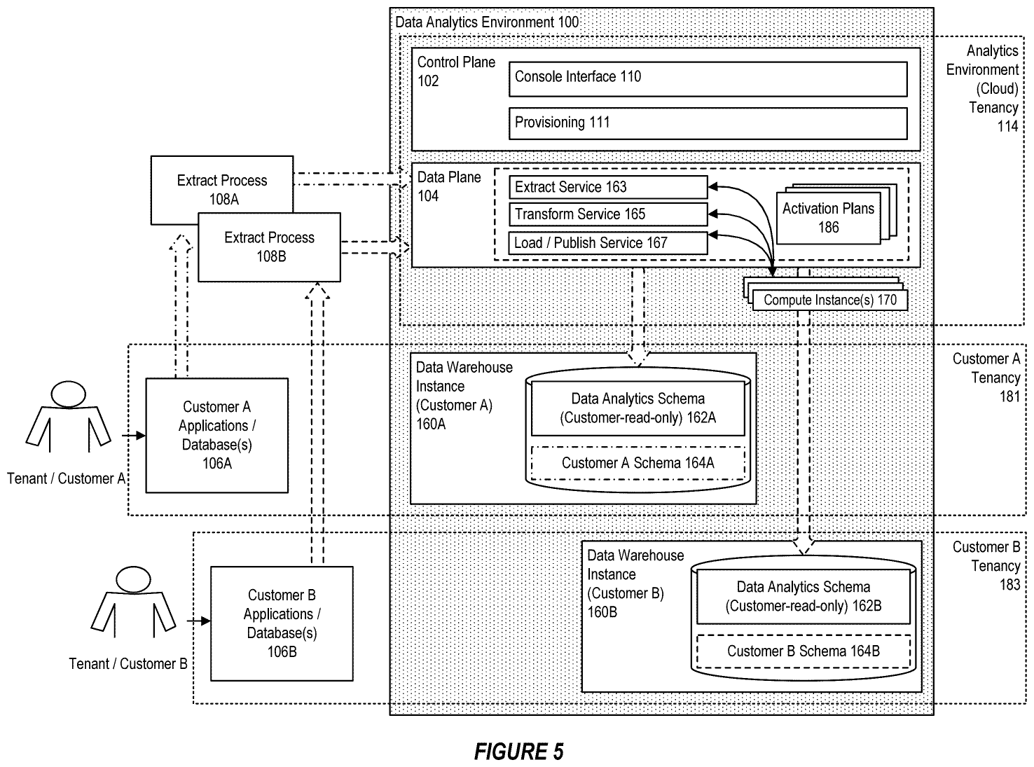

FIG. 5 further illustrates an example data analytics environment, in accordance with an embodiment.

As illustrated in FIG. 5, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

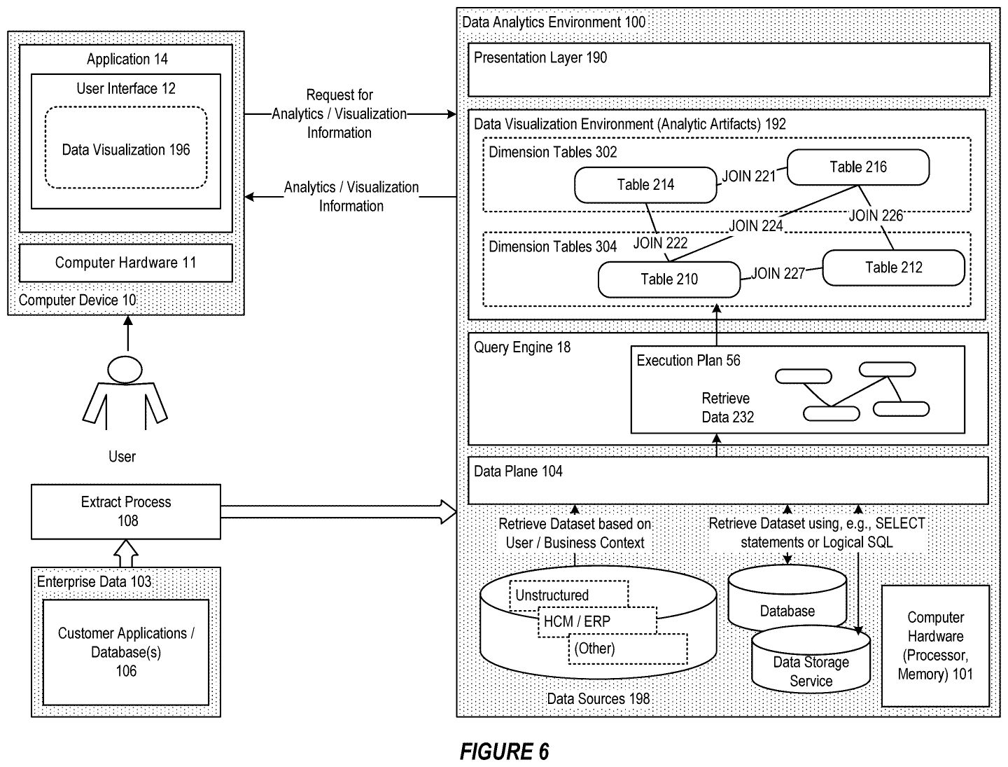

FIG. 6 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 6, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Automated Data Warehouse Creation and Extension

In the field of data analytics, data augmentation allows enterprise customers to enhance their existing sets of data with additional data. For example, a customer can develop datasets created by extending an existing data entity, or by adding a new data dimension, or a new data fact.

However, with current approaches, the process of data augmentation is generally not user-friendly. The user typically needs to have a detailed understanding of their system's existing configuration, and must then manually define each data attribute by navigating through various sets of instructions before they can execute a data analytics job.

In some environments, a data warehouse may be configured by a Business Intelligence (BI) analyst. However, other business users may require certain additional information, and to accommodate this the BI analyst would need to configure the data warehouse accordingly, for example to enrich the data stored therein to provide the required type of information.

Generally, a BI analyst collects, analyzes, and shares data with an audience, and typically collects the data from various sources, which may include industry reports, public information field reports, or purchased findings; analyzes the data to identify trends; performs configuration of ETL and data pipeline requests; and provides dashboards for the consumers of the data who can make decisions using the data and reports.

A BI analyst typically needs to have enough technical depth to perform various BI-related tasks. In some instances, they may need weeks or even months to understand the data, data warehouse schemas, and different business requirements, and consider how they can develop some meaningful representation to the dashboards. Even when bringing a new table to the data warehouse for their business, they may have to sieve though the metadata of the source tables 430 and figure out what is available for them to bring in. They may then need to remember the steps for ETL configuration, and manually execute the steps as needed.

In accordance with an embodiment, described herein is a system and method for automated data warehouse creation and extension from user natural language requests, that mitigates inconveniences with existing data augmentation approaches.

In accordance with an embodiment, the system can be used to provide a recommendation or otherwise guide a user to configure a data warehouse environment, for example to analyze data and identify trends, or to activate a data processing pipeline, or to configure pipeline settings for use within a data analytics environment or data warehouse instance.

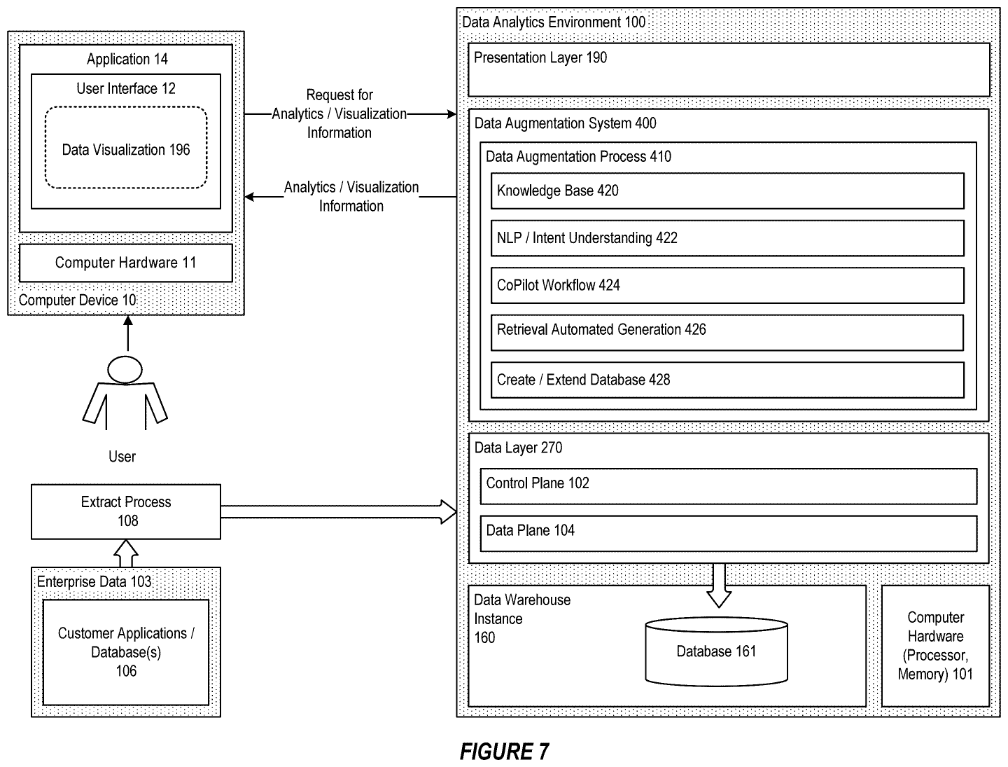

FIG. 7 illustrates a system for automated data warehouse creation and extension from user natural language requests, in accordance with an embodiment.

As illustrated in FIG. 7, in accordance with an embodiment, an automated data augmentation system 400 and data augmentation process 410, operating on one or more computers, comprises one or more of a knowledge base 420, NLP/intent understanding 422 copilot workflow 424, retrieval automated generation 426, and/or create/extend database 428 components, the operation of which are further described below.

In accordance with an embodiment, the system operates to receive a natural language user request as an input with a specific intent or instruction to augment a data, for example to “create” a fact/dimension or “extend” an existing entity by bringing additional columns from a source data and publishing it to a target data warehouse.

In accordance with an embodiment, the system allows a user to enter a natural language input into the system, for example in an interactive or chatbot-type manner, to formulate or provide a user query or other input, in response to which the system can then parse that query, and augment the data warehouse accordingly.

In accordance with an embodiment, the system can understand a user's instruction in plain language terms (for example, “extend sales order transactions with approval status”), and perform an appropriate course of actions to extend the data, without the user needing to know all the details of the existing data warehouse, schemas and other dependencies required for the data augmentation platform.

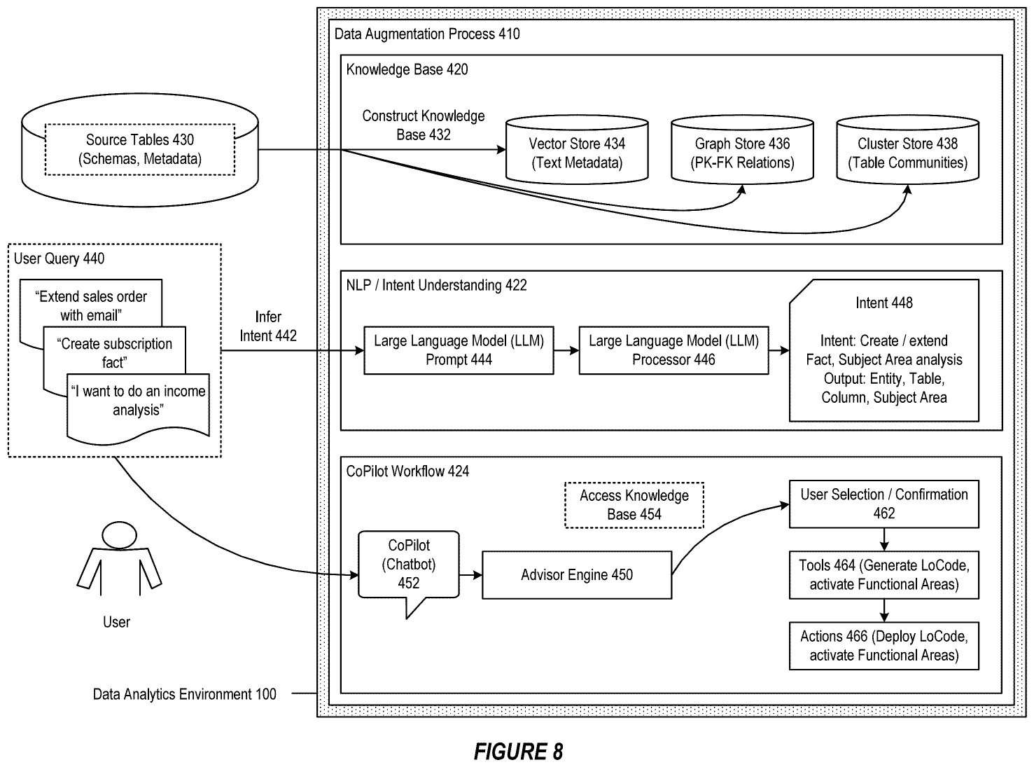

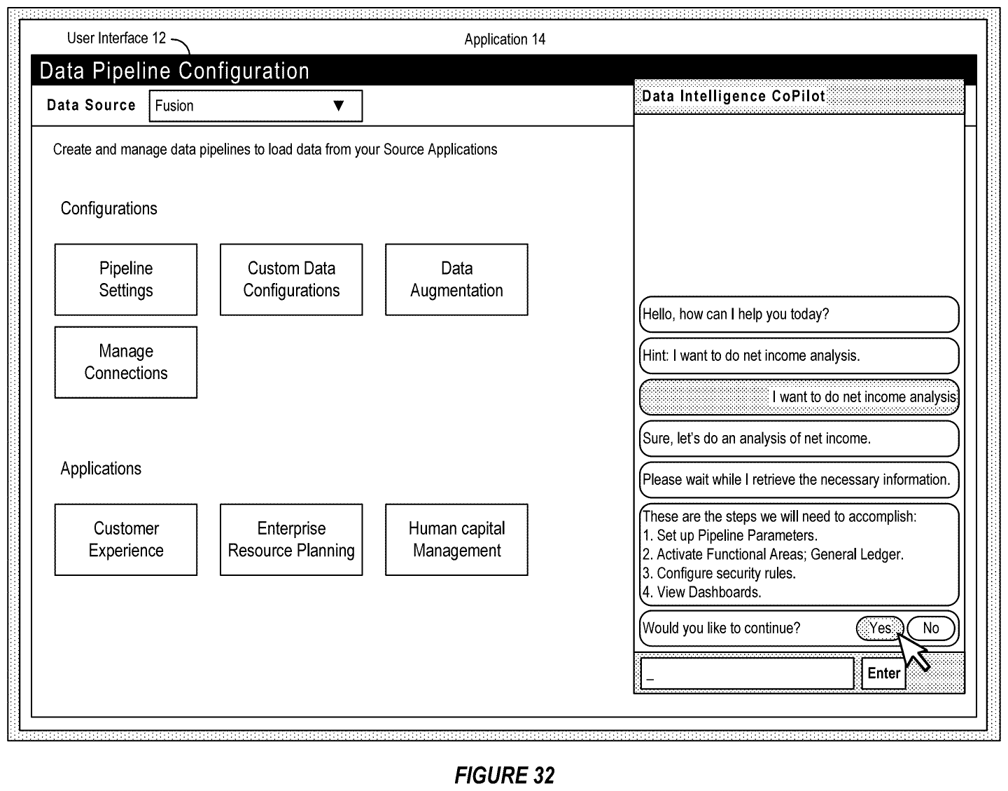

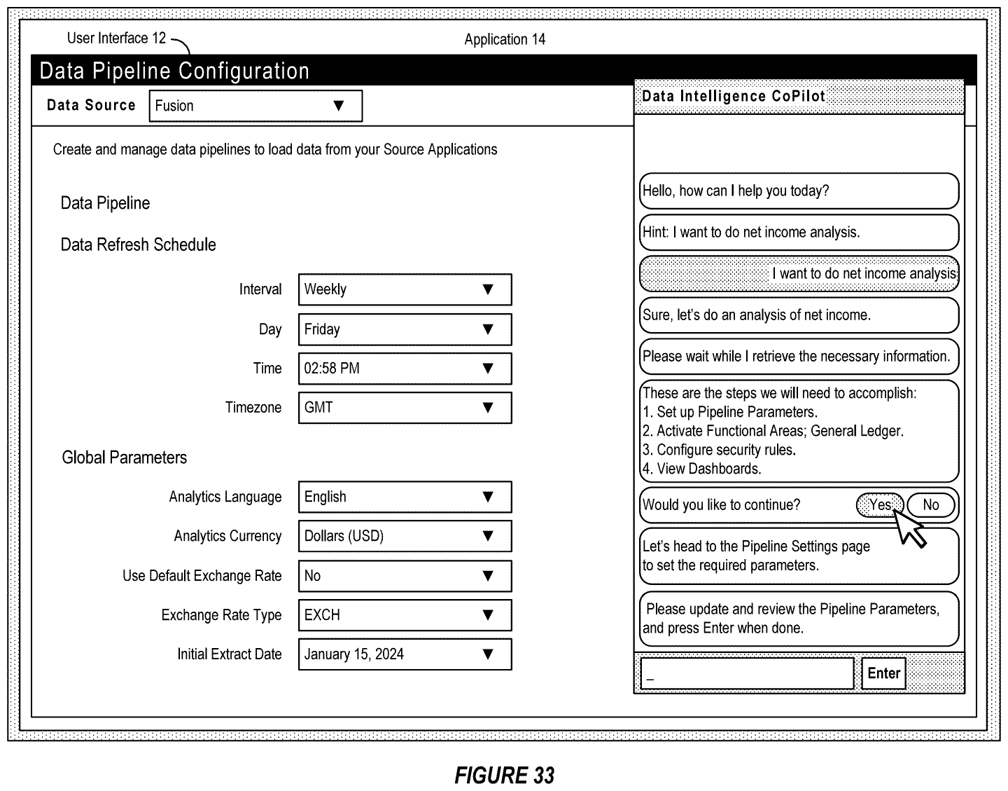

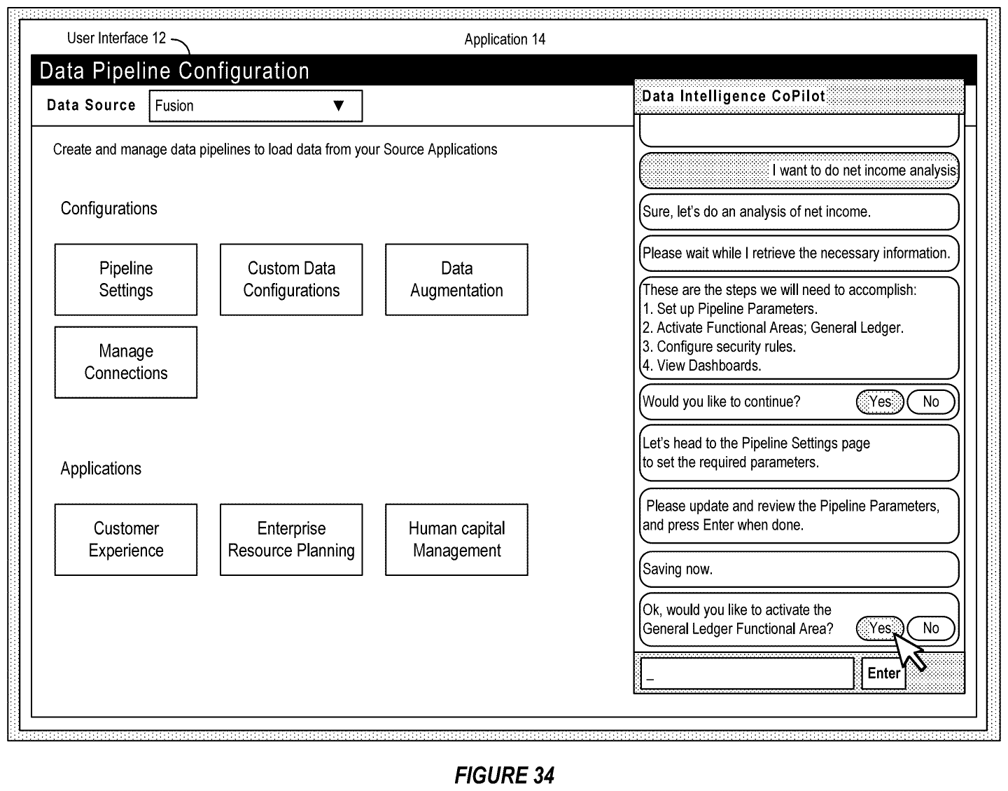

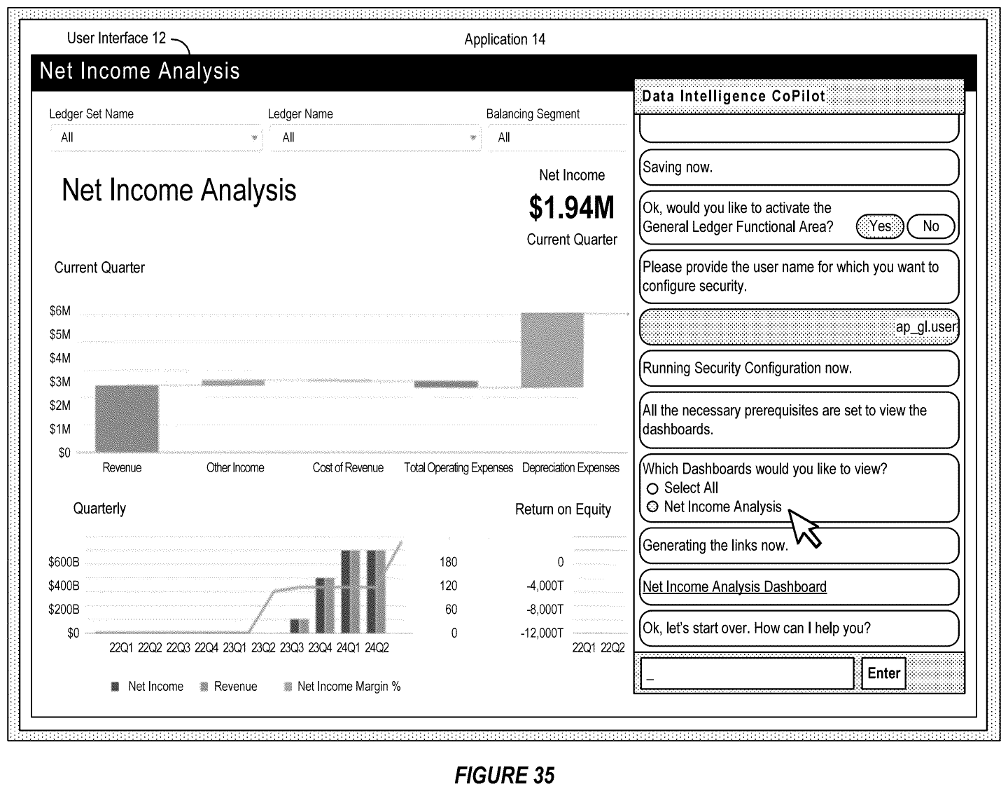

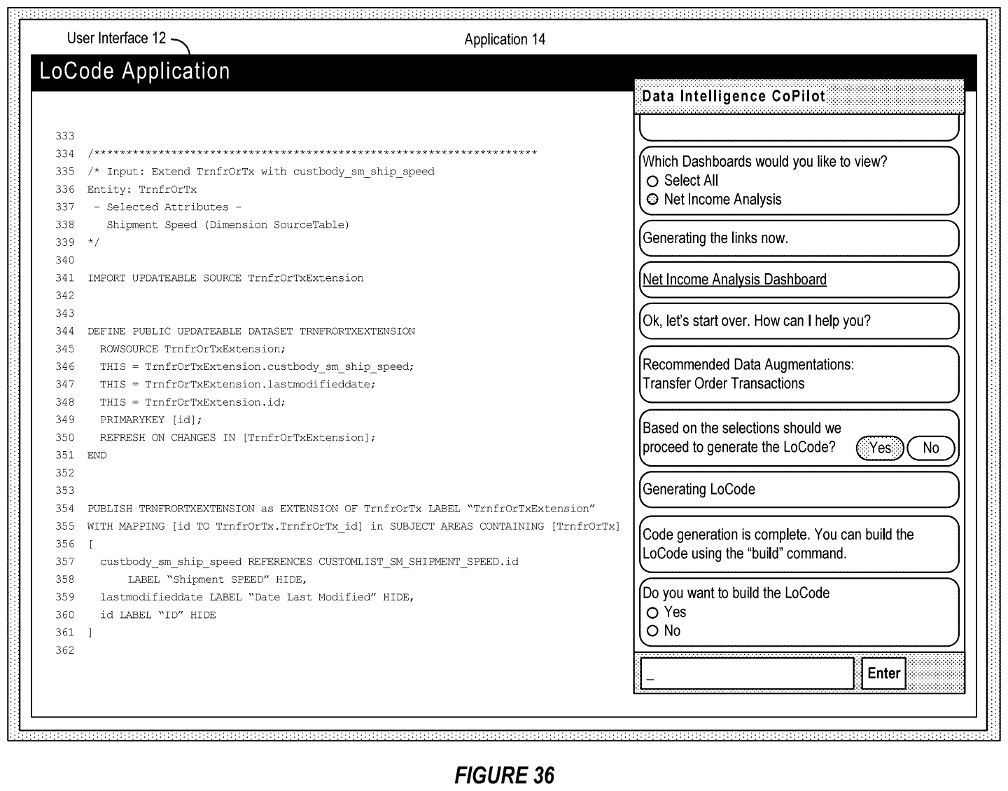

FIGS. 8-36 illustrate automated data warehouse creation and extension from user natural language requests, in accordance with various embodiments, as further described below.

### 1. CoPilot Application

In accordance with an embodiment, the system can include a software application, for example a copilot application (copilot), that operates as an expert to augment the work of BI analysts or functional administrators by performing initialization and repeatable tasks. For example, the copilot can provide recommendations for the BI analysts and functional administrators to help focus on the bigger picture, and is capable of performing different tasks such as but not limited to the following: modifying the data warehouse, for example, to extend and create fact; activating subject areas based on BI needs; navigating to dashboards based on BI needs; or answering queries, which can include ready-made ones in content, and queries that can be answered using, for example, SQL generation with LLM's.

In accordance with an embodiment, the copilot can help perform the sequential steps required to configure a data analytics system or environment to make it ready to use, configure the data coming from various systems, and schedule future refreshes. It can also extend the data that is brought into the system, for example by Oracle Business Intelligence Platform, and create various subject areas to represent the data in a logical way. The copilot can also help build dashboards and reports by interacting with human user and helping them start data analysis.

In accordance with an embodiment, the copilot can also help the customers by acting as an expert who can provide details to various business questions, for example as illustrated below:

### GL Balance Sheet:

How are my asset balances tracking across regions (COA) for last two years?
What is the working capital position and trend for the past X quarters?
What are the CapEx requirements in the near future?
Will PPE hold up, or will an early capital infusion be needed?
How is the debt equity mix structured at present, and is it actionable for improved financial gearing?
What is the trend of AP for the last eight quarters?

### GL Profitability:

What is the proportion of operating profits taken up by interest and financing costs?
What is the trend of gross margins for the past two years across business units?
What is the trend around operating and net margins for the past two years?
What is the composition of fixed cost elements versus variable cost elements for the past two years?

In some environments, data augmentation allows customers to enhance their datasets with additional data. For example, customers can bring datasets created by extending an existing entity, or by adding a new dimension or a new fact. Though this approach can help customers perform their job, the typical process is not very user-friendly. For example, when used with an Oracle data warehouse or system, in order to perform data augmentation, the BI analyst needs to have a good understanding of the system's existing configurations, and may manually need to define every attribute, by navigating through the sets of instructions, before they can activate the job.

In accordance with an embodiment, to mitigate the inconveniences with the existing data augmentation platform, the described approach provides an automated data augmentation system that takes a natural language user request as an input with the specific intent to augment like “create” a fact/dimension or “extend” an existing entity by bringing additional columns from the source and publish it to the target data warehouse.

In accordance with an embodiment, the user can provide an instruction in plain English (for example, “extend sales order transactions with approval status”). The system will understand that and would perform an appropriate course of actions to extend the data, without the user needing to know all the details of the existing data warehouse, schemas and other dependencies required for data augmentation platform.

In accordance with an embodiment, the described approach operates to: take a user input in plain natural language; perform a search, identification and confirmation for data augmentation (extend entity or create fact); find an intent and required information needed for augmentation; automatically gather data warehouse tables, schema and their underlying data models; and provide possible recommendations for extend/create.

In accordance with an embodiment, given a natural language request for data augmentation, the system can transform the request into a readily-consumable format to be integrated with different downstream processes. The described approach generally includes:
1. Providing a user interface (UI) for selection by users;
2. A means of converting extensions to into a code format (referred to herein in some embodiments as a LoCode); and
3. The conversion and execution of the code.

In accordance with an embodiment, the process required for the copilot to work generally includes: generation of a knowledge base; determining an understanding of intent; and then interacting with a user and the copilot in performing an action.

In accordance with an embodiment, the copilot operates to guide the user to bring a relevant set of information into their data warehouse, such as for example different subject areas and functional areas that may need to be activated or loaded to address particular data analytic questions. Each user's domain provides a context for generating reports in response to their user requests or queries.

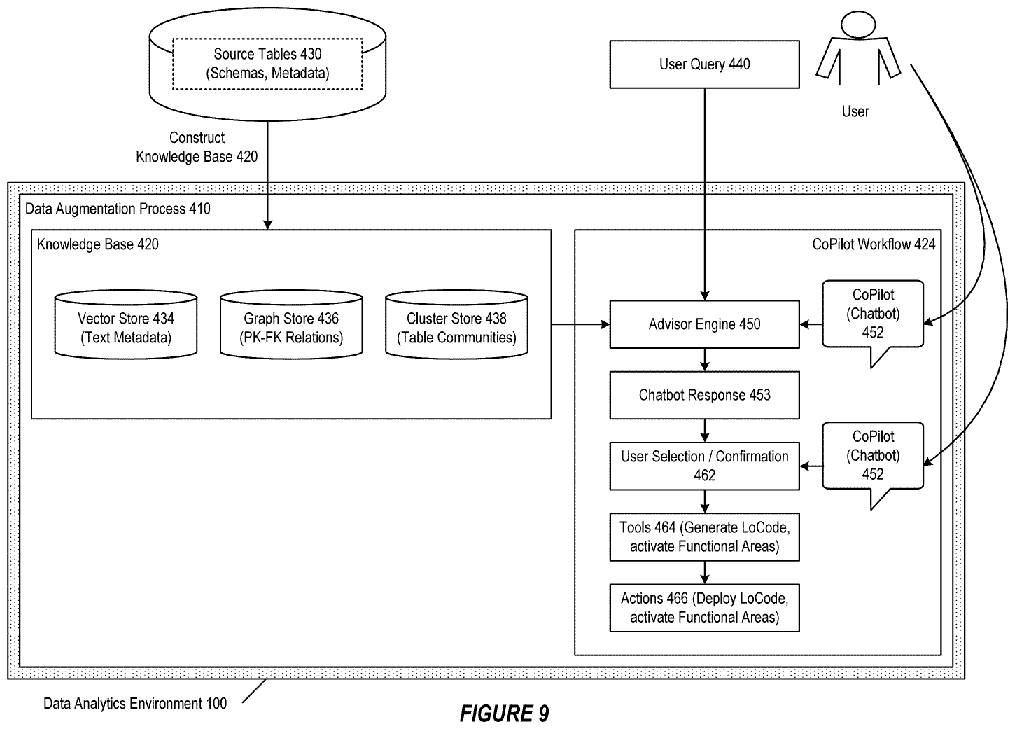

As illustrated in FIGS. 8-9, in accordance with an embodiment, a customer may, for example, like to bring more tables into their data warehouse to supplement their existing data, to infer an intent or understanding, and/or generate appropriate actions.

In accordance with an embodiment, the knowledge base acts as a data lake or repository of data which stores all of the information needed by the system in order to respond to requests. The knowledge base can be constructed 432 or include, for example, a vector store 434, graph store 436, cluster store 438, or other types of data. Depending on the user's access permissions they may have certain access to various sources of data.

In accordance with an embodiment, the system provides intent understanding—for example, the copilot can parse a user query 440 having a natural language input, and infer an intent 442 or understanding associated therewith, based on one or more large language model (LLM) prompt 444 or LLM processor 446, and then determine which, e.g., subject areas entries, or table columns, may be relevant to the inferred intent 448.

In accordance with an embodiment, the system can, by means of a copilot (e.g., operating in the manner of a chatbot) 452, and advisor engine 450, provide guidance or assistance to the BI analyst to assist in processing their user query or other input. Downstream processes, for example those directed to accessing the knowledge base 454, receiving a chatbot response 453 or a user selection/confirmation 462 of possible operations with various tools 464 or actions 466, such as to deploy a LoCode or activate a functional area, can further use the information provided by operation of the copilot.

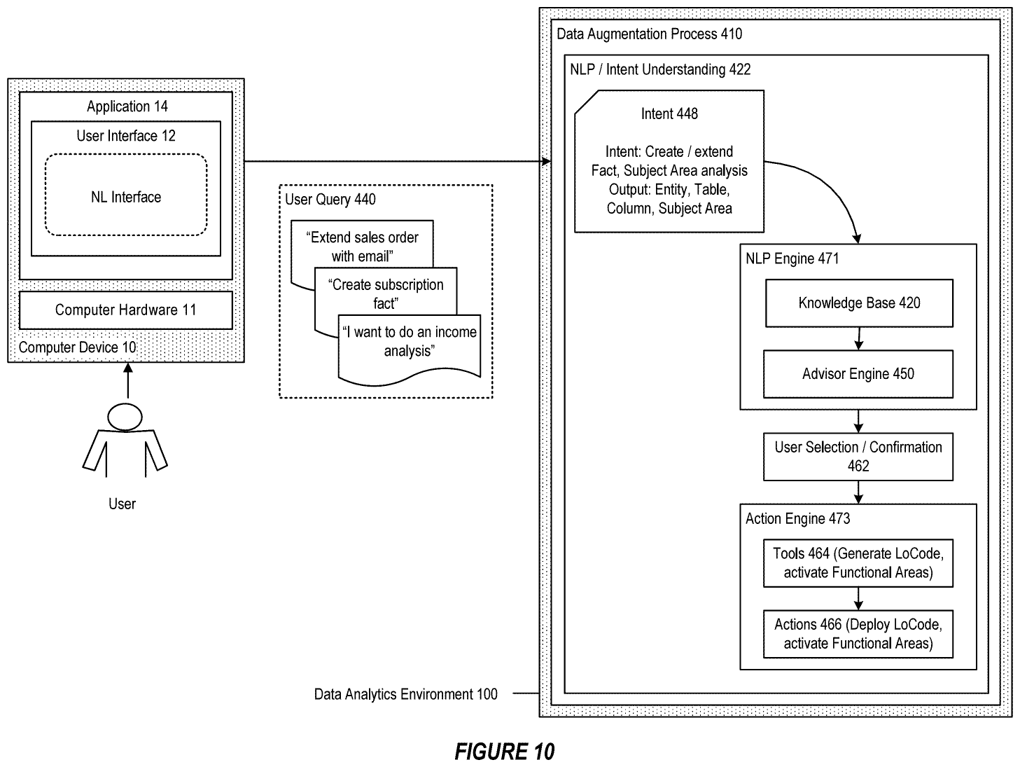

As illustrated in FIG. 10, in accordance with an embodiment, the system can include the use of a natural language processing (NLP) engine 471, and action engine 473, to extract intent information from the user query or other input, connect to the knowledge base to look up additional information relevant to the user's query, or perhaps some other recommendation for the user based on a semantic matching, and then receive the user's confirmation of the recommendation and provide the user with actions from which the user can select to perform. The results can again be further sent to one or more downstream processes, for example a data load, or data augmentation, or other pipeline process.

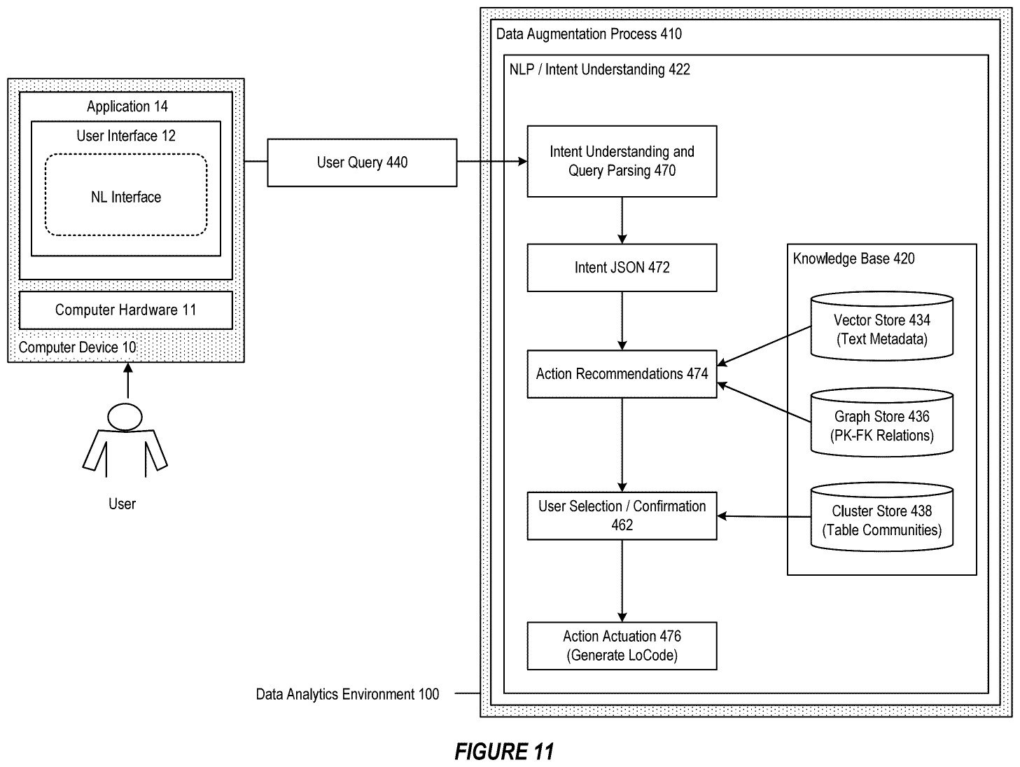

As illustrated in FIG. 11, in accordance with an embodiment, the system can operate to understand the intent and parse the user query or other input 470, create a data structure, for example in an intent JSON format 472, connect to the knowledge base (here including a vector store, graph store, and cluster store), generate a recommendation 474 of one or more actions, and receive a user confirmation followed by an action actuation 476, for example to generate a LoCode.

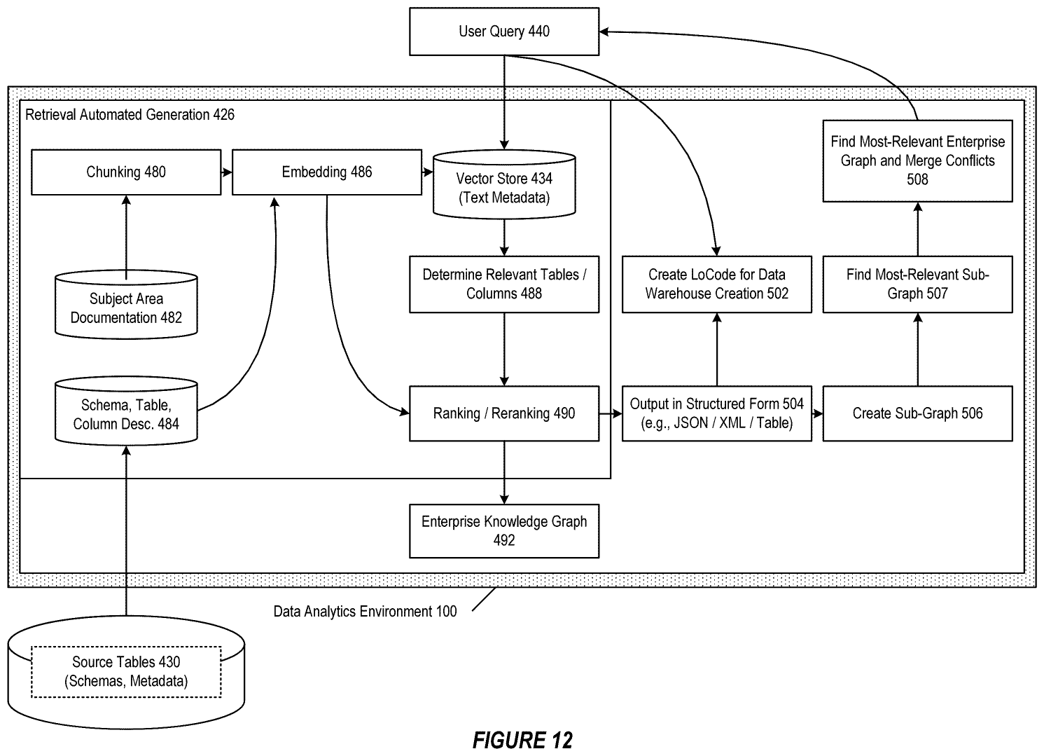

As illustrated in FIG. 12, in accordance with an embodiment, in assessing a user query for intent, additional environments or components, such as a retrieval augmented generation (RAG) process, can be used to bring in other information, such as subject area 482, schemas, or table column description 484.

In accordance with an embodiment, the retrieval augmented generation process can perform a chunking 480 and embedding 486 operation to determine relevant tables/columns 488, performing a ranking 490 as appropriate, and generate an enterprise knowledge graph 492. The system can include additional components to output the findings in a structure form (e.g., a JSON/XML/Table) 504, create sub-graphs 506, find most relevant sub-graphs 507, find most relevant enterprise graph 508, and/or create a LoCode 502.

### II. Knowledge Base (KB) for Modifying Data Warehouse (Data Augmentation)

In accordance with an embodiment, the system includes features for creating the knowledge base.

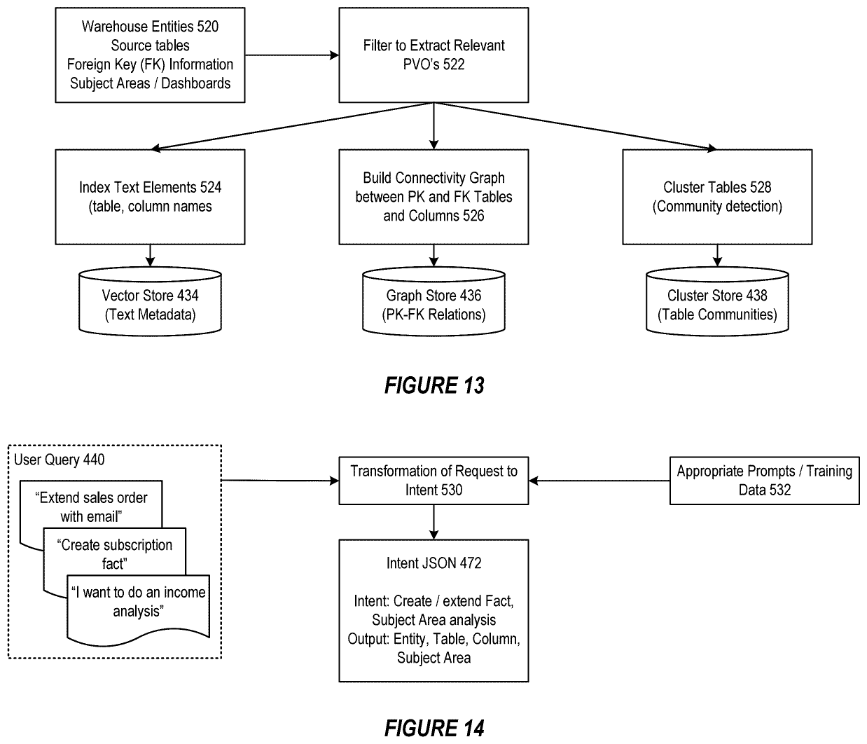

As illustrated in FIG. 13, in accordance with an embodiment, metadata directed to data warehouse entities 520, for example source tables, can be received and filtered 522 to extract relevant vector objects, such as an index of text elements 524, a connectivity graph between primary key (PK) and foreign key (FK) tables 526, and cluster tables 528, which can then be saved in the knowledge base.

For example, in accordance with an embodiment, the knowledge base and metadata can include a data structure which captures different Data Model Definitions (DMD) of the source tables' metadata, such as for example: table level metadata, column level metadata, joining information (foreign key relationships), data warehouse entities information, and source dependent connectors to map logical tables into their base tables.

In accordance with an embodiment, the system can store embeddings of the different components of metadata—column descriptions, table descriptions, table names, for example using a Sentence Transformers stsb-roberta-large model.

In accordance with an embodiment, for a create use case, at a broad level, offline knowledge base generation involves: for every table creating the following: a score from a fact ranker algorithm that indicates the likelihood of the table being a fact; embeddings for table name and table description; and embeddings for column names and their descriptions.

In accordance with an embodiment, for an extend use case, at a broad level, offline knowledge base usage involves:
Pre-processing of the tabular and columnar metadata by cleaning, augmenting, and tokenizing for consumption later. More column level features can be added, for example: column_type (standard or custom column), measure_type (based on datatype, we identify if a column is a measure, attribute, or a reference); in short possible derived information from metadata that can be further used.
Generation of canonical (queries with a pre-defined format—depending on data augmentation use cases) queries for extend: for example, Extend table_name with col1, col2, coln, etc.
Computation of embeddings of these queries.
Formulation of pre-generated recommendations for optimization for optimizing performance of the models in the runtime. Precomputed recommendations are stored as a result for every table and column pairs. So that during real-time, the system can identify a table and column from a user query or other input, and look up this knowledge base for results.

In accordance with an embodiment, the system can include the use of different knowledge bases (KBs) to cater to different categories of queries that the copilot understands. The use cases supported by the system are not restricted to those involving data augmentation (or which make modifications to the data warehouse), but can also utilize metadata or information derived from other sources or domains. For example, to support the ability to process business questions, the system can include a KB that has a comprehensive collection of information on relevant subject areas, functional areas, or different KPIs/Dashboards.

In accordance with an embodiment, the system or copilot also supports multiple pipeline features, such as which functional area to activate; or which subject area to analyze. Each of these specific tasks can be catered for by domain-specific KBs.

### III. Inferring User Intent

In accordance with an embodiment, inferring intent of the user query or other input allows the system to pull the right set of modules or data sources in order to process the user query or other input or return the most appropriate or relevant information. To support this the system can use a variety of small language models (SLM), large language models (LLM), or other types of models.

As illustrated in FIG. 14, in accordance with an embodiment, the system can receive a user request in natural language (e.g., “I want to extend a sales order with email”). The user can effectively say anything to the system; the system will transform 530 the input as a user query or other input or request associated with an intent, based on appropriate prompts/training data 532; and create an intent JSON, for example to create or extend a data fact, and generate an appropriate corresponding output for example an entity, table or column.

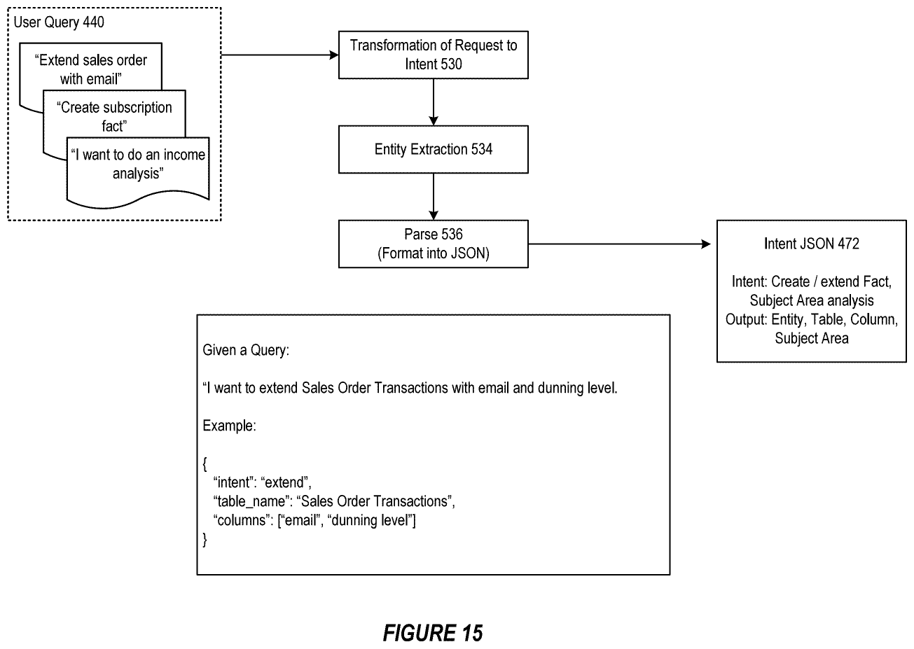

As illustrated in FIG. 15, in accordance with an embodiment, the system can determine how to create or extend tables, based on a determination of the user intent, to support processing of the user query or other input, including transformation of a request to an intent, entity extraction 534, and parsing 536.

The example shown is an output that is then passed to a downstream process, in this example to extend the table as indicated.

In accordance with an embodiment, the method can include:
1. Convert a user intent, which can include the following, but are not limited to:
1.1. Matching syntactic tags to semantic tags using pattern matching and a repository of potential intents and user requests variation.
1.2. Combination of the following techniques: using embeddings, vector similarity measures, classifiers.
1.3. Getting SLMs to generate an intent JSON from a well-directed user intent prompt.
2. Confirm the intent from the user.

In accordance with an embodiment, entity extraction and query parsing can include:
1. Entity extraction from user query.
1.1. For extend:
1.2. Identify table names, and column names from the source, such as, for example, but not limited to, Fusion or NetSuite.
1.3. Combination of methods used can include the following, but are not limited to: generate the training data with the user query and sample entities identified (using the source tables and their column metadata information); use classifiers to identify table names and column names; getting SLMs to identify intent, table names, columns from a well-directed user prompt; output it as an intent JSON formatted string to a dictionary.
2. For create:
2.1. Similar steps as extend can be used for entity extraction.

### IV. Finding a Closest Table Against the Knowledge Base

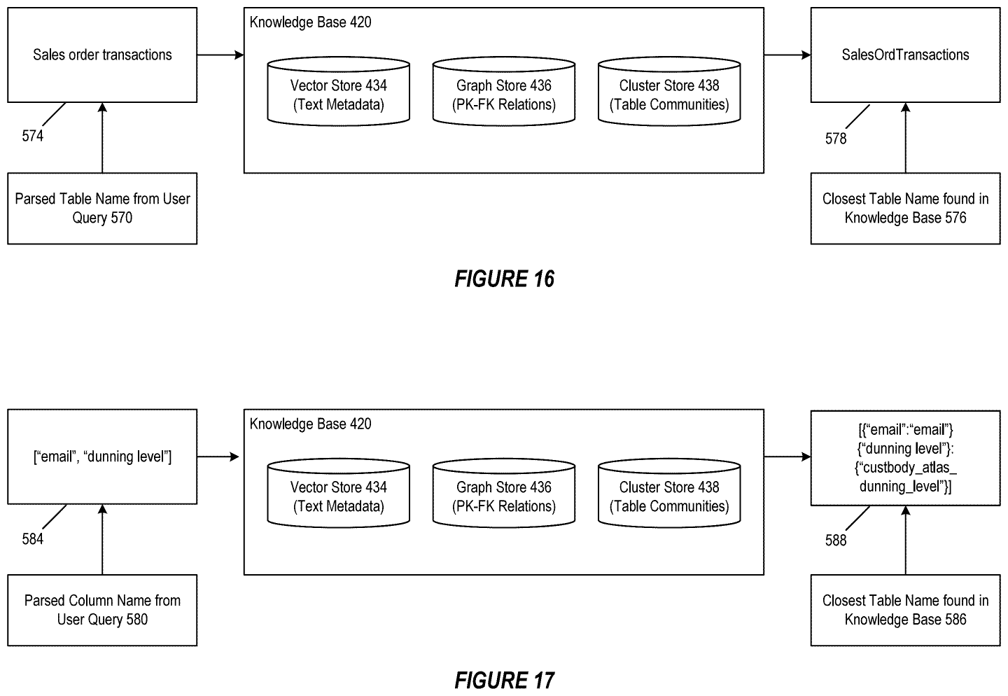

As illustrated in FIGS. 16-17, in accordance with an embodiment, if an exact match is not found in the knowledge base, then the system can operate to find a closet entity and provide that as a recommendation or guidance to the user.

For example, if the system cannot find a particular table or column that exactly-matches a parsed table name 570 or parsed column name 580, it can suggest, based on its understanding of existing tables and columns (574, 576, 584, 586), what it believes to be a close alternative 578, 588.

In accordance with an embodiment, once the table name is extracted, the system can compute both string matching; and semantic similarity against the table names and their embeddings stored in the knowledge base; and take a weighted average of the scores to get the closest table name present in the knowledge base.

In accordance with an embodiment, once the table is identified, the system can look at the column level information from the knowledge base (column name, column description, and their embeddings); compute both string matching against column names, and their description; and semantic similarity against the column description's embeddings; and take a weighted average of the scores to get the closest column name.

### V. Data Augmentation Scenarios

In accordance with an embodiment, the described approach can be used to support various data augmentation scenarios, for example to extend and entity, or create a fact.

### Extend Entity (Scenarios)

In accordance with an embodiment, as described above, in some instances it may be desired to extend a data warehouse table, for example for a customer to bring in additional or other types of data to support their data analytics or use case.

In accordance with an embodiment, after determining an intent associated with a user query or other input, the system can perform a validation of that intent, and then provide the recommendation to the customer. For example, the system can base the recommendation on a syntactic or semantic assessment of the user query or other input, to determine an understanding.

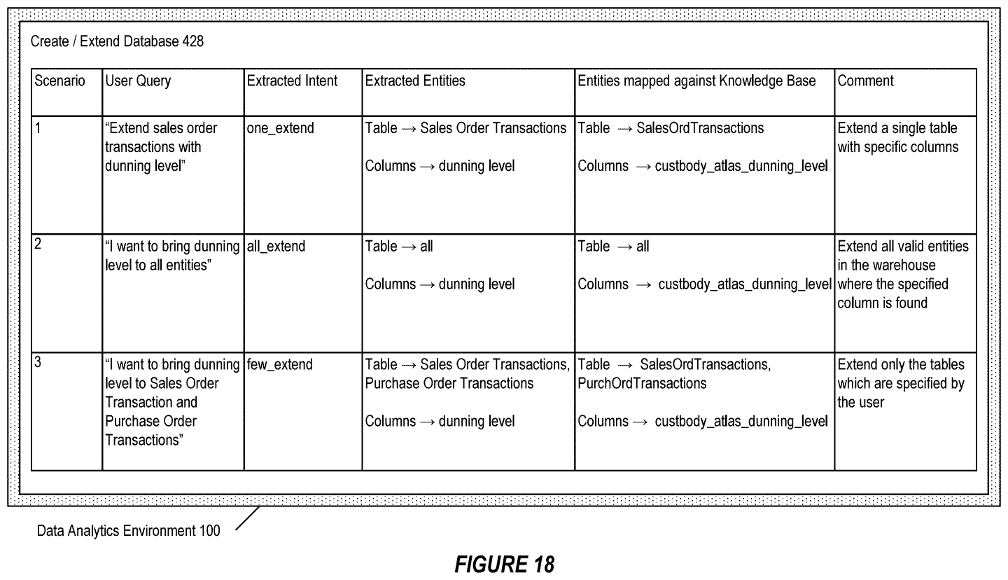

As illustrated in FIG. 18, in accordance with an embodiment, the system can receive a user query or other input; determine an extracted intent and extracted entities; map the entities against the knowledge base; and if appropriate provide a comment associated with the extend scenario. In each case the system can perform a validation on the mapping before receiving the user confirmation.

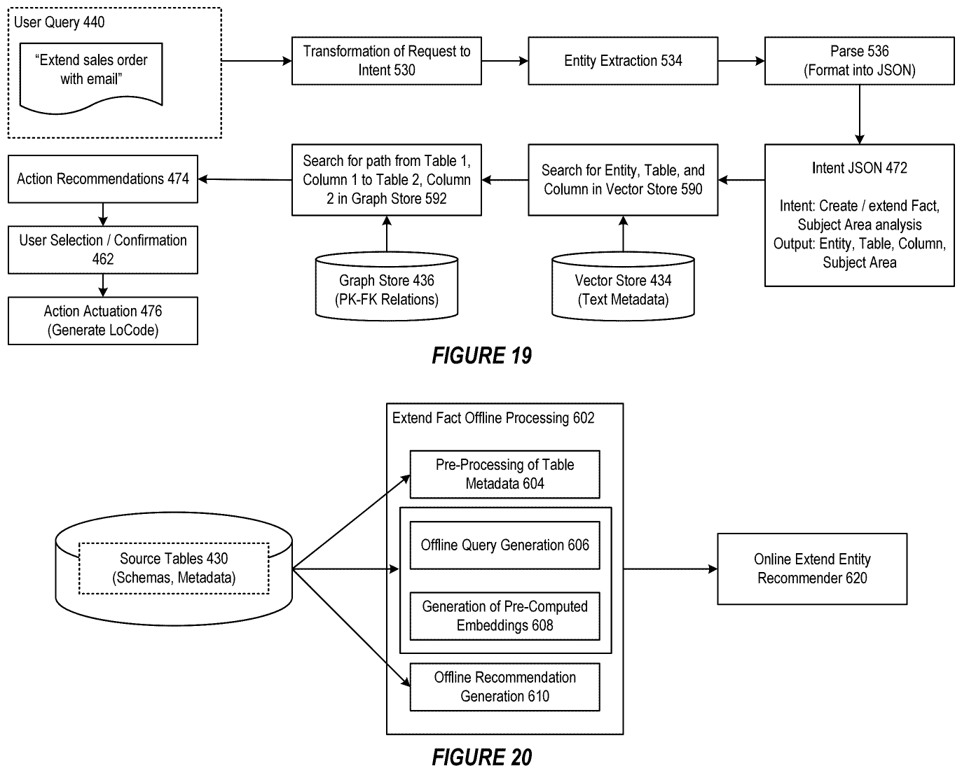

As illustrated in FIG. 19, in accordance with an embodiment, the system can perform an extend entity workflow where it builds the intent JSON; searches 590 for a table mapped within the knowledge base; receives the confirmation from the user; generates the recommendation (e.g., table or column); and then generates the code that will provide a path 592 to bring the actual data into the data warehouse.

As illustrated in FIG. 20, in accordance with an embodiment, the system can operate so that knowledge base generation is an offline process 602, including pre-processing of table metadata 604, offline query generator 606, generation of pre-computed embeddings 608, and offline recommendation generation 610; which information can then be provided to an online extend entity recommender 620.

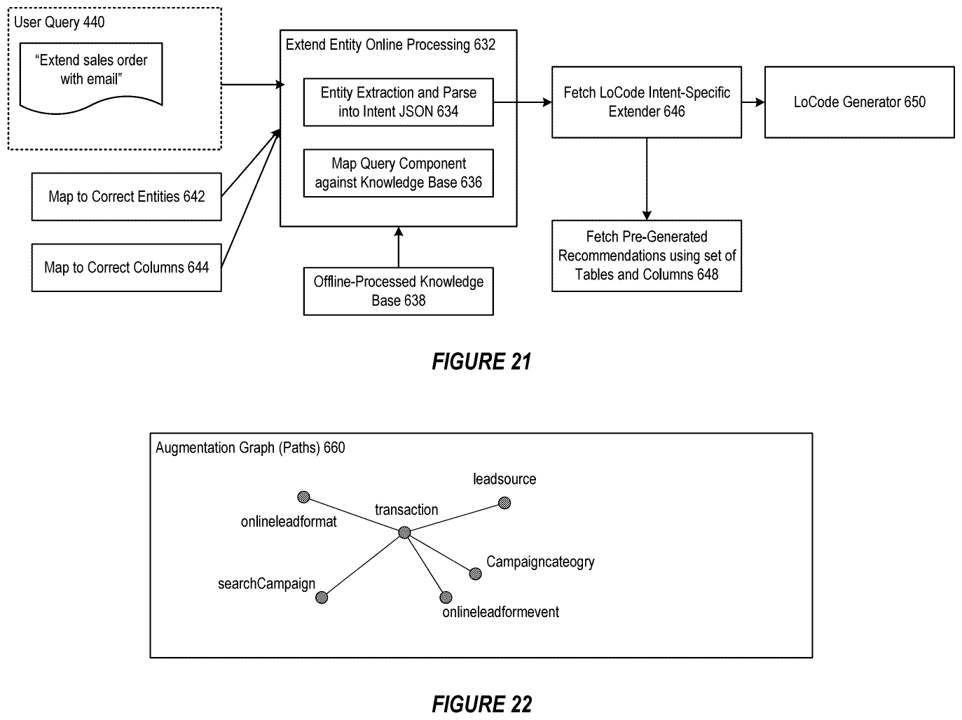

As illustrated in FIG. 21, in accordance with an embodiment, the system can operate so that the extend entity workflow is an online process 632, including entity extraction and parsing into the intent JSON 634, and mapping of query component against knowledge base 636, based on a mapping to correct entities 642 and correct columns 644. If the table and column can be identified then the system can, at runtime, determine the appropriate extension, and generate the code to extend the data warehouse.

In accordance with various embodiments, different code format (LoCode) generators can be used to address various use cases. Effectively the code generators operate as one or more phases or modules that know how to extend a data warehouse to address a particular use case, including for example a confirmation phase (confirmation module); and recommendation phase (recommendation module). The system can operate to fetch an intent-specific extender 646 and fetch pre-generated recommendations using the set of tables and columns 648, and provide the results to the LoCode generator 650.

As illustrated in FIG. 22, in accordance with an embodiment, when the system determines a table or column, it can assess whether that column is linked to another dimension (or table), and then create a directed augmentation graph of metadata 660 for use in determining the recommendations or paths for the user. The directed graph information can be stored in the graph datastore within the knowledge base.

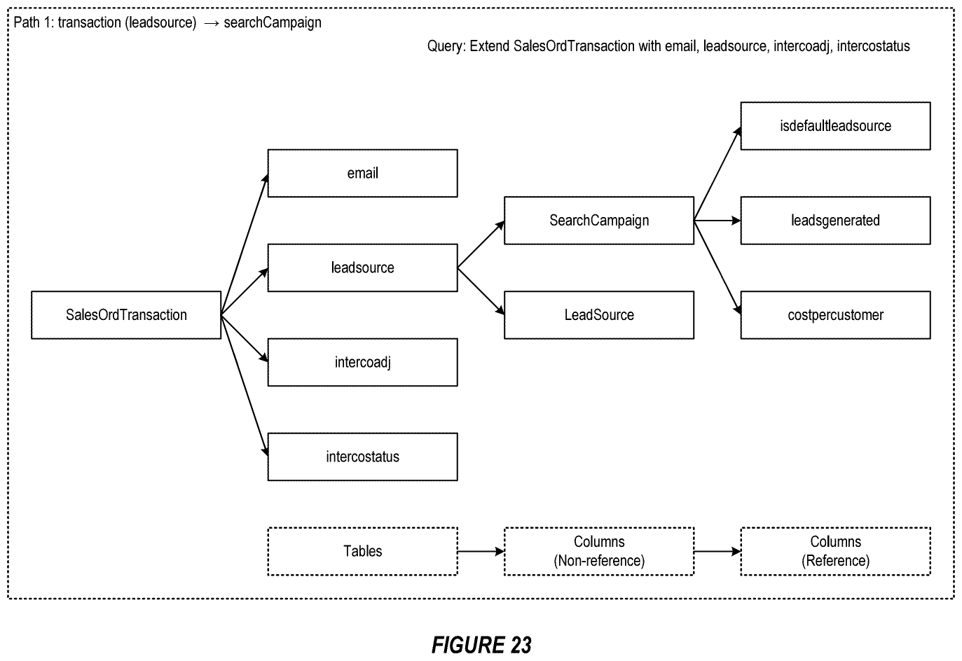

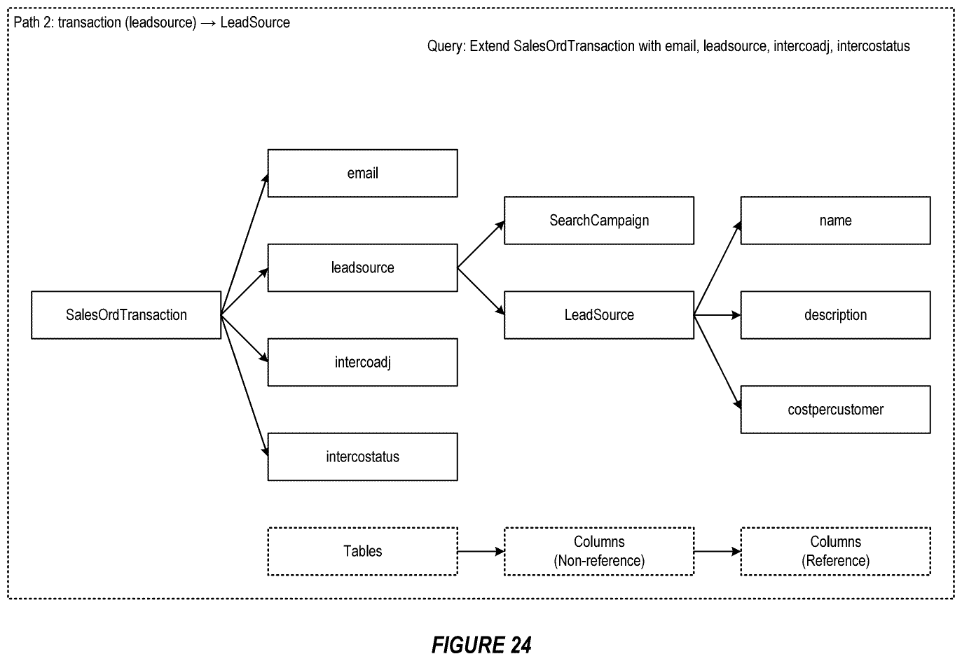

As illustrated in FIGS. 23 and 24, in accordance with an embodiment, for example, a transaction table can be associated with additional dimensions and additional columns according to the directed graph.

In accordance with an embodiment, the role of extend includes: extending a table with some columns (custom columns or standard) and bringing it to the data warehouse. This is to allow users to define their own tables based on their requirement.

In accordance with an embodiment, with the extend use case, the system can understand the intent from a natural language text, and then bring relevant table and column information (looking up from the knowledge base), using retrieval techniques, into a structured format which is consumable by a bot or user interface (UI).

In accordance with an embodiment, various example scenarios are illustrated below.
Scenario 1: “I want to extend Sales Order Transactions with dunning level and approval status”.
Scenario 2: “Bring dunning level and email to Sales Order Transactions and Purchase Order Transactions”.
Scenario 3: “I want to add dunning level to all tables”.

In accordance with an embodiment, the data augmentation extension process or algorithm has two phases: confirmation; and recommendation.

In accordance with an embodiment, during the confirmation phase: the system allows users to confirm if the intent, table, and columns are correct. If not, they will have an option to rephrase their query.

In accordance with an embodiment, during the recommendation phase: for the table verified at the confirmation stage, the system provides recommendations for the columns confirmed by the user at the confirmation stage. Along with the recommended columns, the system can also provide other column details, such as, if a column is a reference, then dimension details along with suggested columns in the dimension which seems to be relevant to the user query or other input.

In accordance with an embodiment, the confirmation phase can include the following (using the example presented in Scenario 1): Extend Sales Order Transactions with dunning level): Identify intents (which is extend). Extract entities (table name, and columns). Match the table name extracted from the user query, and get the closest table(t) present in the knowledge base. For the table t found, we match the columns extracted and bring the closest columns for that table using the knowledge base. For example, Sales Order Transactions=SalesOrdTransactions; Dunning level=custbody_atlas_dunning_level; Approval status=approvalstatus.

Scenario 1: Extend Sales Order Transactions with Dunning Level.

In accordance with an embodiment, for this scenario, the workflow can comprise:
1. User will be shown entity to confirm.
2. Once the user confirms entity, specific columns will be surfaced out for selection.
3. Once both the entities and columns are selected: 1. Canonical query will be formed: Extend SalesOrdTransactions with custbody_atlas_dunning_level. 2. Recommendation module will be called for all further column suggestions and column details.
   Scenario 2: I want to Bring Dunning Level to all Entities.

In accordance with an embodiment, for this scenario, the workflow can comprise:
1. User will be shown columns to confirm.
2. Once the user confirms columns, then based on the columns selected, specific entities where these columns are found will be shown in the user interface.
3. User now selects the entities from the above list (2).
4. Once the entities are selected:
5. Then for every entity selected entity, a canonical query will be created (for example, Extend SalesOrdTransactions with custbody_atlas_dunning_level) and recommender module is invoked. This will return the required fields for the code format (LoCode) to use internally.
6. Confirmation from the user to proceed to build.
   Scenario 3: I want to Bring Dunning Level to Sales Order Transactions and Purchase Order Transactions.

In accordance with an embodiment, for this scenario, the workflow can comprise:
1. User will be shown columns to confirm.
2. Once the user confirms columns, then based on the columns selected, specific entities (Sales Order Transactions) NOT Purchase Order Transactions (as the column dunning level is not found in it) will be shown in the user interface.
3. User now selects the entities from the above list (2).
4. Once the entities are selected:
5. Then for every entity selected entity, canonical query will be created (for example, Extend SalesOrdTransactions with custbody_atlas_dunning_level.) and recommender module is invoked. This will return the required fields for the code format (LoCode) to use internally
6. Confirmation from the user to proceed to build.

### Data Augmentation—Extend Entity

In accordance with an embodiment, the data augmentation—extend entity (recommendation or core algorithm) can comprise:
1. For every column (from the user query), compute both lexical and semantic similarity across the whole columnar data stored in knowledge base.
1. Score=Max(Jaccard(tokens from processed column description embedding), Cosine(processed column description's embedding)), Dice(column name) with the column name (email)). In this example, Jaccard, Cosine, and Dice reflect the use of Jaccard, Cosine, and Dice similarity indexes, coefficients, or scores.
2. Then take (table name, column name tuple) as dict (key, score).
3. Select tuples with cutoff score=0.55.
4. Pick top_k=5 for every table from the above tuple list
5. For every candidate (table_column pair), look at FKEYS table's FK_table, FK_column. If there is an entry, define an edge from FK_table to its corresponding PK_table. The system can maintain an edge_list for all such cases. If there is no entry, then we mark them discovery=direct, otherwise, discovery=indirect.
6. Construct a directed graph using edge_list created in (5).
7. Set the table to be extended (transaction) as the root, then go through truncated dictionary to add nodes and edges to form a digraph (based on FKEYS knowledge base metadata).
8. Then find all paths from root to leaves.
9. Provide paths (if they exist) only if they have the (table, column) among the selected candidates, or return just the valid (table, column) in an intent JSON format.
2. The system can combine all the suggested attributes for every user queried column(s) to form the recommendation output long with other column details.

### Data Augmentation—Extend Entity (Recommendation—Column Features)

Adding column features. For every column recommended, the following attributes are added:
A column_type. Attribute/measure/reference. If reference, we provide dimension_details.
A measure_type. Aggregations (defaulted to SUM, will allow changes in the code format (LoCode) editor).

Decided rules for column_type.
1. If dataType in BIGINT or VARCHAR or CHAR, check OA_FKEYS for outward references and detect dimensions. If matched, it is a Dimension, else it is an Attribute.
2. If dataType is DOUBLE, then if matched, it is a Measure column. use SUM as default aggregation.
3. If dataType in (DATE or TIMESTAMP) then it is an Attribute.
4. If dataType is CLOB. If matched LongObjectAttribute, as of now reject with reason echoed to user.

### Data Augmentation—Extend Entity (Recommendation—Dimension Details)

Adding dimension_details (for a query like Extend SalesOrdTransactions with nextapprover). A nextapprover column is a reference.

If column_type==reference:
Populate:
dimension_details: {“entity_type”: “factory”,
   “entity_name”: “employee”,
   “entity_label”: “Employee”,
   “entity_primary_cols”:
   [{“id”: “employee_id”, “name”: “employee_id}]}
Decided Rule: From OA_FKEYS metadata, PK_table is identified as dimension. Check in the data warehouse_entities.json, if the dimension details already exists in the factory, update dimension_details (shown above). Else, we mark entity_type=non_factory, and return FK and PK joining information from OA_FKEYS metadata to create a new dimension.

### Data Augmentation—Extend Entity (Recommendation—Directed Graph)

Constructing directed graph. For example, Extend SalesOrdTransactions with email, leadsource, intercoadj, intercostatus. Here, leadsource is a reference.

### Data Augmentation—Create Fact (Scenarios)

In accordance with an embodiment, a user may need to create a custom table, for example a table may already exist but the user may want to enrich the existing table; or the user may instead want to create a completely new table with new columns, which can be more challenging. To address this, the system can support an understanding of connected tables.

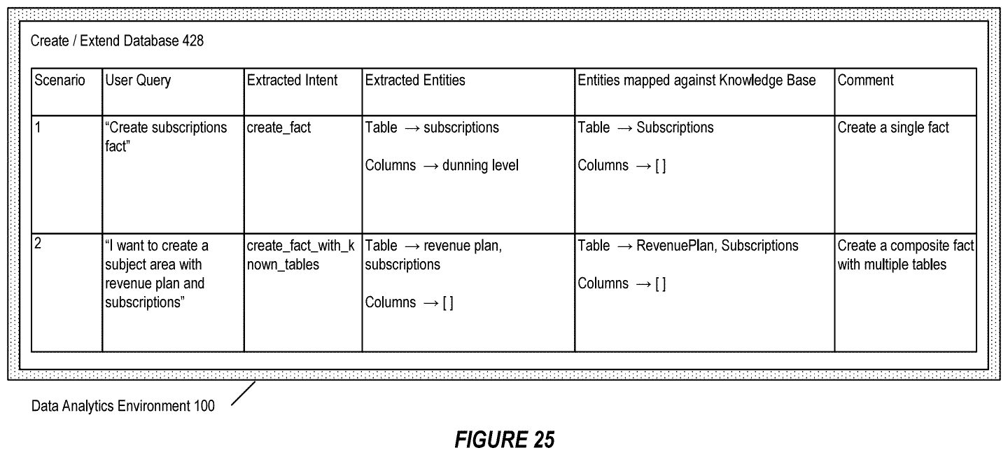

As illustrated in FIG. 25, in accordance with an embodiment, the system can be used to create a fact; or create a subject area.

For example, in accordance with an embodiment the system can present to the user a similar table or column that already exists and receive feedback from the user.

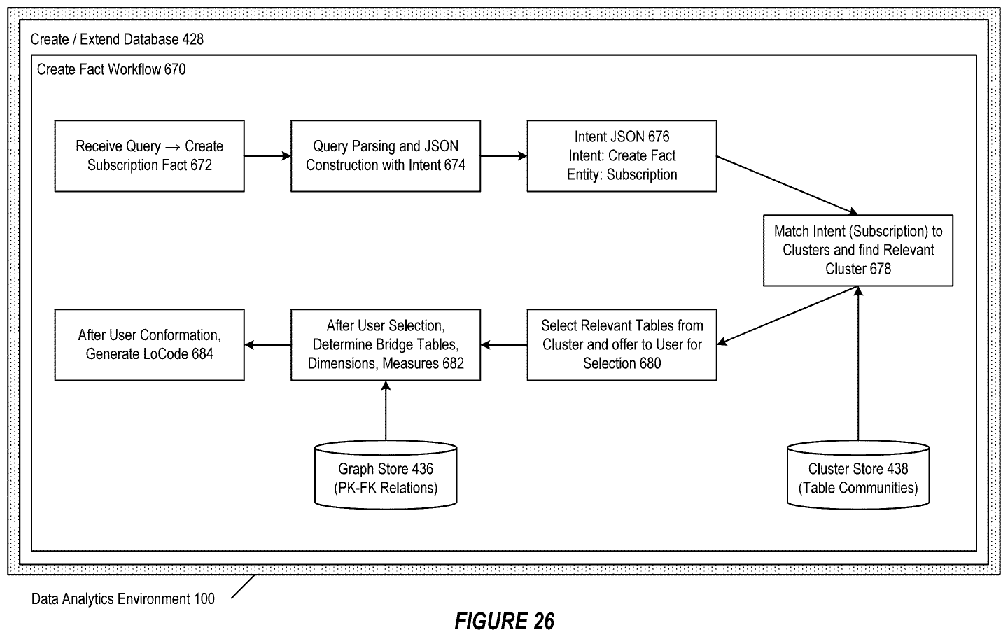

As illustrated in FIG. 26, in accordance with an embodiment, the system can use a create fact workflow 670, here to create a subscription fact 672; and parse the user query or other input 674 and construct a JSON intent 676. Here the system can, based on matching the intent 678, select relevant tables 680 from a cluster of relevant tables, and offer that to the user for selection 682. Following user confirmation, the system can proceed to generate a LoCode 684.

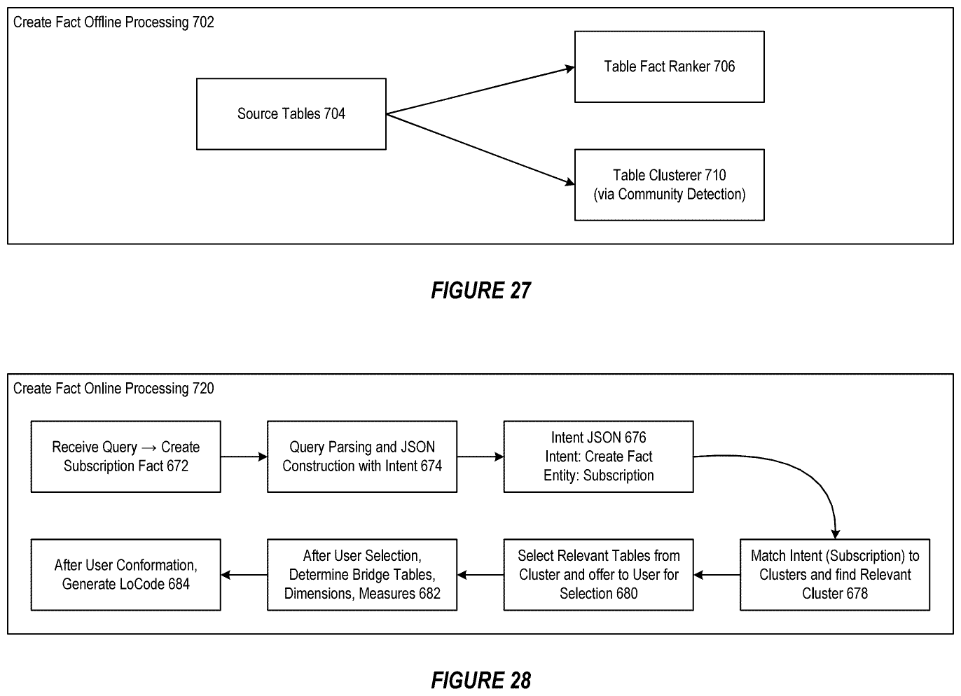

As illustrated in FIG. 27, in accordance with an embodiment, during create fact offline processing 702, the system can determine source tables 704 and determine whether the table is a fact or dimension table for purposes of ranking 706 determining a cluster of related tables 710.

As illustrated in FIG. 28, in accordance with an embodiment, during create fact online processing 720, once the knowledge base has been populated with the clusters, it can be used to determine relevant tables, in response to a user query or other input, and generate a corresponding code format (LoCode).

In accordance with an embodiment, with the create use case, the system can understand the intent from a natural language text, and then bring relevant table information (looking up from the knowledge base and provide column specific details to choose to create a new subject area.
Scenario 1: “I want to create revenue plan fact”.
Scenario 2: “I want to create a subject area with revenue plan and subscriptions”.

In accordance with an embodiment, the data augmentation create fact use case has two phases: confirmation; and recommendation.

In accordance with an embodiment, during the confirmation phase: we allow users to confirm if the intent and table are correct. If not, they will have an option to rephrase their query.

In accordance with an embodiment, during the recommendation phase: for the table verified at the confirmation stage, the system can provide recommendations of other similar tables, based on the scenarios and relevant columns and other attributes and dimensions to bring in.

Scenario 1: In accordance with an embodiment, for single fact creation, the algorithm is as follows:
1. Group the source tables into multiple clusters or communities (a cluster is a subgraph with densely connected nodes, for example as determined by Louvain community detection or Girvan-Newman methods).
2. Create an embedding for every cluster (an embedding of a cluster is the mean of all table embeddings within that cluster).
3. Compute the similarity of user query with all clusters and max-normalize the similarities (the best cluster will have a score of 1).
4. Choose clusters having a maximum normalized score of 0.8 or higher (i.e., select tables having at least 80% of the best score).
5. For all tables in all clusters, compute a similarity of user query with every table and max-normalize the similarity score (intra cluster normalization).
6. Chose only such tables having a maximum normalized score of 0.8 or higher.
7. Relevance of table=w1×table_sim+w2×fact_score (identify w1 and w2 empirically). Relevant facts are ones having at least a certain relevance score (empirically determine the cut off for relevant facts).

In accordance with an embodiment, when a table of the user query is matched against the knowledge base, it is not always guaranteed that it would be a fact; the system can use a fact ranking algorithm to disambiguate between a fact and a dimension.

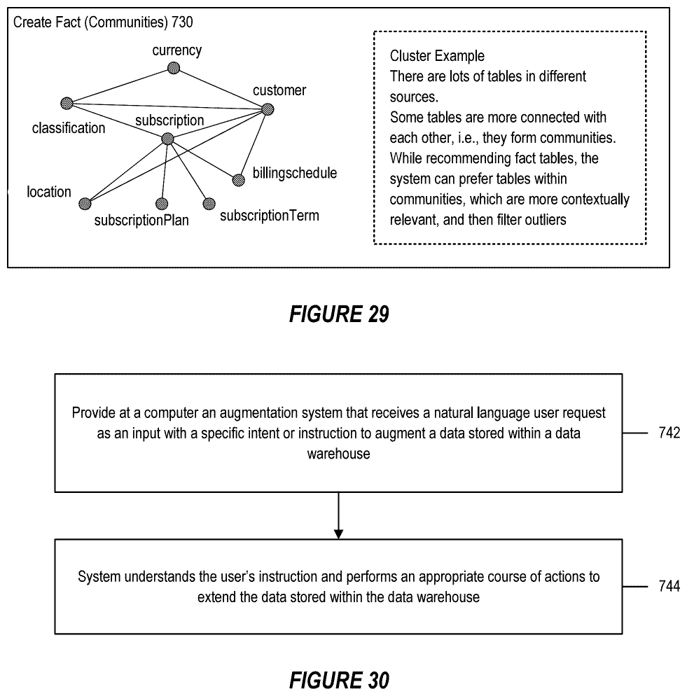

As illustrated in FIG. 29, in accordance with an embodiment, in a data augmentation create fact (communities) 730 cluster example, there may be lots of tables in different sources, not limited to Fusion or NetSuite environments. But some tables are more connected within each other, i.e., they form communities. While recommending fact tables, the system can prefer tables within communities, which are more contextually relevant; and filter outliers.

FIG. 30 illustrates a process automated data warehouse creation and extension, in accordance with various embodiments.

As illustrated in FIG. 30, in accordance with an embodiment, in a first step 742, an augmentation system receives a natural language user request as an input with a specific intent or instruction to augment a data stored within a data warehouse. Subsequently at 744, the system understands the user's instruction and determines and performs a corresponding course of actions to extend the data stored within the data warehouse.

In accordance with an embodiment, the role of create includes: when a fact/dimension does not exist, then the user is required to build their own using existing source tables with specific columns. A new subject area is created through augmentation and brought into the data warehouse. This is catered towards a user's specific needs, which may not be provided in the existing data warehouse.

In accordance with an embodiment, a fact ranking algorithm can include one or more of the following, which are further aggregated: structural ranker; links ranker; business process ranker; table ranker; neighbor vote ranker.

In accordance with an embodiment, the system can include various other types of fact rankers that are used to create facts for subsequent use by the system in providing recommendations, or to support other use cases.

In accordance with an embodiment, a compute structural ranker looks into different data patterns and label tables into facts and dimension. Facts will have more datetime columns, numeric columns, and high date continuity. This fact ranker provides or assigns score to a table based on: the number of datetime columns, the number of numeric columns, and the number of unique timestamps in the table.

A normalized_datetime_feature=number of datetime columns/total number of columns.

A normalized_numeric_feature=number of numeric columns/total number of columns.

A date_continuity_factor=avg. unique dates/system live duration (system live duration is the max(date) across all tables−min(date) across all tables).

The above scores can be max normalized across all tables (as we take a weighted sum later).

$$structural\_weighted \_score = w 1 \times normalized\_datetime \_feature + w 2 \times normalized\_numeric \_feature + w 3 \times date\_continuity \_factor ( w 1 = 0.3 , w 2 = 0.3 , and w 3 = 0.4 currently )$$

(w1=0.3, w2=0.3, and w3=0.4 currently)

In accordance with an embodiment, business process ranking segregates tables based on its usage in different business processes in which they belong. Facts are usually related to some business processes. This fact ranker can maintain a list of known business processes; for example: business_processes=[Inventory Management, Receivables, Payables etc.]. For every column, compute the Dice coefficient or score of the column with all business processes. The col_score=maximum of such Dice scores.

In accordance with an embodiment, a table's business_process_score=sum of all col_scores/total number of columns. The business_process_score=business_process_score/business_process_score.max( ). A table ranker operates on the basis that facts may contain columns that are pointing to many tables. Here a column_score=number of tables in which current column is present. The table_score=sum of all column_scores. table_rank_score=table_score/table_score.max( ).

In accordance with an embodiment, an example of a data augmentation create fact (fact ranker) can comprise:

$$weighted\_score \_ 1 = w 1 \times structural\_weighted \_score + w 2 \times link\_score + w 3 \times business\_process \_score + w 4 \times table\_rank \text{} \_score ( w 1 = 0.65 , w 2 = 0.25 , w 3 = 0.05 , w 4 = 0.05 currently )$$

(w1=0.65, w2=0.25, w3=0.05, w4=0.05 currently)

In accordance with an embodiment, a neighbor vote ranker operates on the basis that facts are usually present at the top, e.g., transaction→vendor→vendorAddressBook. An iterative page rank or other algorithm can be used to bump up the scores of the top-most tables):
while (i<5)
   neighbour_vote_score=sum of weighted_score_1 of all outgoing links;
   i++
neighbour_vote_score=neighbour_vote_score/neighbour_vote_score.max( )

Scenario 2: In accordance with an embodiment, for fact creation with known tables (for example, I want to create a subject area with revenue plan (t1) and subscriptions (t2)), the algorithm is as follows:
1. Compute semantic similarity with table metadata from the knowledge base to bring all similar tables to t1. Keep top K %.
2. Compute semantic similarity with table metadata from the knowledge base to bring all similar tables to t2. Keep top K %.
3. Now using FKEYS metadata from the knowledge base, an undirected graph is constructed using tables 1 and 2.
4. Now if there exists a path (irrespective of the number of hops) between t1 and t2, then we consider all the tables in that path.
5. Provide them as recommendations to the user to create a new subject area.

### Example User Experience and User Interface

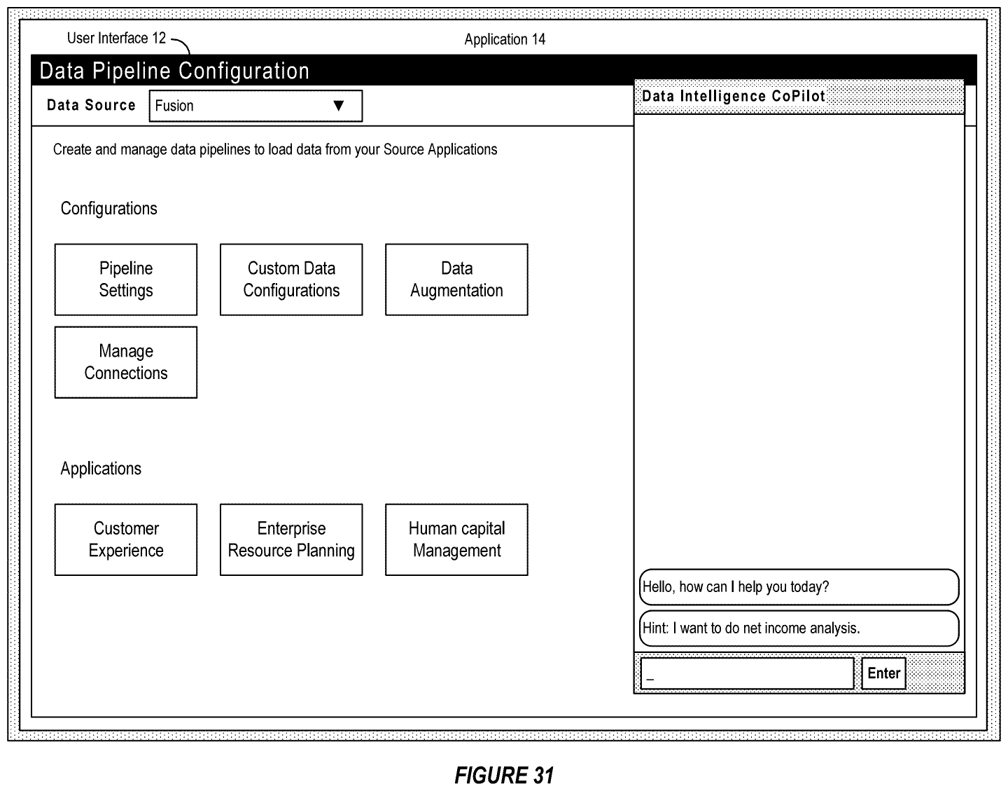

FIGS. 31-36 illustrate an example use of automated data warehouse creation and extension from user natural language requests, in accordance with various embodiments.

In particular, in accordance with an embodiment, FIGS. 31-36 illustrate various examples of how the approach described herein can be used within a data pipeline configuration environment, for example as part of a data intelligence copilot, to drive an application user interface in providing recommendations or otherwise guiding a user to configure a data warehouse environment, including, for example, generating a data visualization dashboard, or generating a LoCode for use with the data pipeline in creating, extending, or otherwise augmenting a data warehouse.

### Example Advantages

In accordance with an embodiment, example advantages of the described approach include, for example, that the customer does not need to know details about a source data schema, the source tables and existing data warehouse tables, the facts and dimensions, or the manual processing to identify dimensions and joining; while avoiding the cognitive overload required of traditional data augmentation techniques.

### Additional Knowledge Bases

The above-described examples illustrates the use of the system and an appropriate knowledge base for purposes of modifying a data warehouse or providing data augmentation. In accordance with various embodiment, the system can include a variety of different or additional knowledge bases, to address particular use cases.

For example, in accordance with an embodiment, the system can include knowledge bases that allow the copilot to guide the user through different pipeline settings, for example activating functional areas within the data, or enabling or disabling different configuration features.

As described above, the variety of different or additional knowledge bases can be used to look up additional information relevant to the user's query, provide recommendations, receive the user's confirmation, or provide the user with actions from which the user can select to perform. The resulting information can then be further sent to one or more downstream or other pipeline processes.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for automated data warehouse creation and extension from user natural language requests, comprising:
a computer including one or more processors and a data augmentation system provided therein and operable to receive a natural language input from a user, including an instruction to augment a set of data for storage within a data warehouse instance;
wherein the data augmentation system determines an understanding associated with the natural language input or user instruction, and determines and performs a corresponding course of actions to create, extend, or otherwise augment the set of data.

2. The system of claim 1, wherein the system operates to receive a natural language user request as an input with a specific intent or instruction to augment a data, to create a fact/dimension or extend an existing entity by bringing additional columns from a source data and publishing it to a target data warehouse.

3. The system of claim 1, wherein the system allows a user to enter a natural language input into the system in an interactive or chatbot-type manner, to formulate or provide a user query or other input, in response to which the system can then parse that query, and augment the data warehouse accordingly.

4. The system of claim 1, wherein the system operates to provide a recommendation or otherwise guide a user to configure a data warehouse environment, for example to analyze data and identify trends, or to activate a data processing pipeline, or to configure pipeline settings for use within a data analytics environment or data warehouse instance.

5. The system of claim 1, wherein the system is provided as part of a cloud-based computing or data analytics environment.

6. A method for automated data warehouse creation and extension from user natural language requests, comprising:
providing, at a computer including one or more processors, a data augmentation system provided therein and operable to receive a natural language input from a user, including an instruction to augment a set of data for storage within a data warehouse instance;
wherein the data augmentation system determines an understanding associated with the natural language input or user instruction, and determines and performs a corresponding course of actions to create, extend, or otherwise augment the set of data.

7. The method of claim 6, wherein the system operates to receive a natural language user request as an input with a specific intent or instruction to augment a data, to create a fact/dimension or extend an existing entity by bringing additional columns from a source data and publishing it to a target data warehouse.

8. The method of claim 6, wherein the system allows a user to enter a natural language input into the system in an interactive or chatbot-type manner, to formulate or provide a user query or other input, in response to which the system can then parse that query, and augment the data warehouse accordingly.

9. The method of claim 6, wherein the system operates to provide a recommendation or otherwise guide a user to configure a data warehouse environment, for example to analyze data and identify trends, or to activate a data processing pipeline, or to configure pipeline settings for use within a data analytics environment or data warehouse instance.

10. The method of claim 6, wherein the system is provided as part of a cloud-based computing or data analytics environment.

11. A non-transitory computer readable storage medium, including instructions stored thereon which when read and executed by one or more computers cause the one or more computers to perform a method comprising:
providing a data augmentation system operable to receive a natural language input from a user, including an instruction to augment a set of data for storage within a data warehouse instance;
wherein the data augmentation system determines an understanding associated with the natural language input or user instruction, and determines and performs a corresponding course of actions to create, extend, or otherwise augment the set of data.

12. The non-transitory computer readable storage medium of claim 11, wherein the system operates to receive a natural language user request as an input with a specific intent or instruction to augment a data, to create a fact/dimension or extend an existing entity by bringing additional columns from a source data and publishing it to a target data warehouse.

13. The non-transitory computer readable storage medium of claim 11, wherein the system allows a user to enter a natural language input into the system in an interactive or chatbot-type manner, to formulate or provide a user query or other input, in response to which the system can then parse that query, and augment the data warehouse accordingly.

14. The non-transitory computer readable storage medium of claim 11, wherein the system operates to provide a recommendation or otherwise guide a user to configure a data warehouse environment, for example to analyze data and identify trends, or to activate a data processing pipeline, or to configure pipeline settings for use within a data analytics environment or data warehouse instance.

15. The non-transitory computer readable storage medium of claim 11, wherein the system is provided as part of a cloud-based computing or data analytics environment.
